(19) United States
(12) Patent Application Publication
(10) Pub. No.: US 2022/0386610 A1
(43) Pub. Date: Dec. 8, 2022

(54) FUNGICIDAL COMBINATIONS

(71) Applicants: UPL Corporation Limited, Port Loui (MU); UPL Europe LTD, Wasrrington (GB)

(72) Inventors: Mariani Alessandro, West Palm Beach, FL (US); Bruno Wolffenbüttel Carloto, Tatuí (BR); Luis Gustavo Rodrigues Gonella, Tatuí (BR); Kim Gary Watson, Indian Harbor Beach, FL (US)

(21) Appl. No.: 17/775,766

(22) PCT Filed: Dec. 4, 2020
(86) PCT No.: PCT/IB2020/061496

§ 371 Date: May 10, 2022

(30) Foreign Application Priority Data
Dec. 5, 2019 (IN) 201921050091

(51) Int. Cl. A01N 43/60; A01N 43/653; A01N 43/56; A01N 43/40; A01N 47/24; A01N 43/08; A01P 3/00

(52) U.S. Cl. CPC A01N 43/60; A01N 43/653; A01N 43/56; A01N 43/40; A01N 47/24; A01N 43/08; A01P 3/00

(57) ABSTRACT

Disclosed herein are fungicidal combinations comprising at least one SDHI fungicide and at least two systemic fungicides and compositions comprising said combinations. Also provided is a method of controlling fungal diseases with said combinations.

### TECHNICAL FIELD

The present invention relates to a combination of fungicides. More specifically, the present invention relates to fungicidal combinations comprising succinate dehydrogenase inhibitor fungicides for controlling a broad spectrum of fungal diseases.

### BACKGROUND OF THE INVENTION

Fungicides are an integral and important tool yielded by farmers to control diseases, as well as to improve yields and quality of the crops. There are various fungicides that have been developed over the years with many desirable attributes such as specificity, systemicity, curative and eradicant action and high activity at low use rates.

Succinate dehydrogenase inhibitor (SDHI) fungicides are known in the art to be broad spectrum and have a high potency. Pyrazolecarboxamides are a group of active compounds within the SDHI family of fungicides that are known to be more potent than most other SDHI fungicides. These molecules specifically bind to the ubiquinone-binding site (Q-site) of the mitochondrial complex II, thereby inhibiting fungal respiration. These fungicides are known to control a broad spectrum of fungal diseases.

Various other classes of fungicides are also known in the art, such as Quinone outside inhibitors (QoIs), ergosterol-biosynthesis inhibitors, fungicides that act on multiple sites, fungicides that affect mitosis etc. These fungicides have been mixed with SDHI fungicides to achieve a broad spectrum of disease control.

WO2006037632 teaches combinations of SDHI fungicides with a second active compound. WO2013127818 teaches combinations of SDHI fungicides with various herbicides. WO2006037634 teaches methods of controlling fungi using a combination of SDHI fungicide with various fungicides. However, the prior art does not teach the use of ternary or higher combinations of SDHI fungicides.

There is a need in the art to improve on the disease spectrum provided by these combinations, particularly with a view to overcoming the resistance being developed to these fungicides.

There is therefore a need in the art for combinations of these SDHI fungicides with other fungicides that helps improve spectrum and overcoming the resistance seen with these fungicides. As crop tolerances are decreasing, lower use rates being imposed and resistance being increasingly observed, there is a need for a combination of actives that allows for broader disease control spectrum that combines curative and preventive actives and has a lower dosage requirement for efficacious control of fungi.

Therefore, embodiments of the present invention may ameliorate one or more of the above mentioned problems:

### One or More Advantages of the Present Invention

Therefore, embodiments of the present invention may provide combinations of fungicides that possess an enhanced efficacy over the individual fungicides used in isolation.

Another object of the present invention is to provide a fungicidal combination that causes an enhanced greening of the crops to which it is administered.

Another object of the present invention is to provide a fungicidal combination that causes late senescence to the crop to which it is applied thereby resulting into an increasing yield of the crop.

Yet another object of the present invention is to provide a fungicidal combination that results into reduced fungal disease incidence in the crops to which it is applied.

Another object of the present invention is to provide a fungicidal combination that achieves increased yield in the crops to which it is applied.

Some or all these and other objects of the invention are can be achieved by way of the invention described hereinafter.

### SUMMARY OF THE INVENTION

Thus, an aspect of the present invention can provide a fungicidal combination comprising at least one succinate dehydrogenase inhibitor fungicide and at least two fungicides selected from Demethylation Inhibitor (DMI) fungicides or Quinone outside Inhibitors (QoI) fungicides or a combination of Demethylation Inhibitor (DMI) fungicides and Quinone outside Inhibitors (QoI) fungicides.

Another aspect of the present invention can provide synergistic fungicidal compositions comprising at least one succinate dehydrogenase inhibitor fungicide and at least two fungicides selected from Demethylation Inhibitor (DMI) fungicides or Quinone outside Inhibitors (QoI) fungicides or a combination of Demethylation Inhibitor (DMI) fungicides and Quinone outside Inhibitors (QoI) fungicides.

### DETAILED DESCRIPTION

The term ‘disease control’ as used herein denotes control and prevention of a disease. Controlling effects include all deviation from natural development, for example: killing, retardation, decrease of the fugal disease. The term ‘plants’ refers to all physical parts of a plant, including seeds, seedlings, saplings, roots, tubers, stems, stalks, foliage and fruits. The term “locus” of a plant as used herein is intended to embrace the place on which the plants are growing, where the plant propagation materials of the plants are sown or where the plant propagation materials of the plants will be placed into the soil. The term “plant propagation material” is understood to denote generative parts of a plant, such as seeds, vegetative material such as cuttings or tubers, roots, fruits, tubers, bulbs, rhizomes and parts of plants, germinated plants and young plants which are to be transplanted after germination or after emergence from the soil. These young plants may be protected before transplantation by a total or partial treatment by immersion. The term “agriculturally acceptable amount of active” refers to an amount of an active that kills or inhibits the plant disease for which control is desired, in an amount not significantly toxic to the plant being treated.

Succinate dehydrogenase inhibitor (SDHI) fungicides play an important role in plant protection against many phytopathogenic fungi. These molecules specifically bind to the ubiquinone-binding site (Q-site) of the mitochondrial complex II, thereby inhibiting fungal respiration.

It has surprisingly been found that the addition of a Succinate dehydrogenase inhibitor (SDHI) to the combinations of at least two systemic fungicides selected from Demethylation Inhibitor (DMI) fungicides or Quinone outside Inhibitors (QoI) fungicides or a combination of Demethylation Inhibitor (DMI) fungicides and Quinone outside Inhibitors (QoI) fungicides resulted in surprising and unexpected synergy and other advantages. In this embodiment, the second and third fungicides are selected such that they are at least two of demethylation inhibitors or two of the quinone outside inhibitors or a combination of one demethylation inhibitor and one quinone outside inhibitor.

Therefore, in an embodiment, the combination of the present invention is at least a triple combination of systemic fungicides.

It has further been found that the addition of Succinate dehydrogenase inhibitor (SDHI) to these combinations and application of these combinations during the flowering stage of the crop delayed the senescence in the crop to which they were applied, which led to better greening in the crop thereby increasing the level of photosynthesis occurring within the plant, thereby leading to a greater yield from the crop to which they were applied.

These surprising advantages of the combinations of the invention were not observed when Succinate dehydrogenase inhibitor (SDHI) was not present in the combination. Therefore, these unexpected advantages of the combination of the present invention could be attributed to the inclusion of a Succinate dehydrogenase inhibitor (SDHI) to the combination of at least two fungicides selected from Demethylation Inhibitor (DMI) fungicides or Quinone outside Inhibitors (QoI) fungicides or Demethylation Inhibitor (DMI) fungicides and Quinone outside Inhibitors (QoI) fungicides.

The present inventors have found that in the absence of the SDHI fungicides of the present invention, the combination of at least two fungicides selected from Demethylation Inhibitor (DMI) fungicides or Quinone outside Inhibitors (QoI) fungicides or Demethylation Inhibitor (DMI) fungicides and Quinone outside Inhibitors (QoI) fungicides shows a reduction of control effectiveness by continuous use over successive years. It was found that the addition of SDHI fungicides not only enhanced the percentage control, but also reverted the observed control to the original level, which was surprising. Thus, the gradual decay in the percentage efficacy seen by the use of “at least two fungicides selected from Demethylation Inhibitor (DMI) fungicides or Quinone outside Inhibitors (QoI) fungicides or Demethylation Inhibitor (DMI) fungicides and Quinone outside Inhibitors (QoI) fungicides” over the years was reversed with the addition of the SDHI fungicides

Thus, in an aspect, the present invention provides a fungicidal combination comprising:
(a) at least one succinate dehydrogenase inhibitor fungicide; and
(b) at least two fungicides selected from Demethylation Inhibitor (DMI) fungicides or Quinone outside Inhibitors (QoI) fungicides or a combination of Demethylation Inhibitor (DMI) fungicides and Quinone outside Inhibitors (QoI) fungicides.

In an embodiment, the succinate dehydrogenase inhibitor is selected from pyrazole carboxamide class of succinate dehydrogenase inhibitor fungicides. However, it should be understood that the choice of succinate dehydrogenase inhibitors is not understood to be limited to these pyrazole carboxamide fungicides alone.

In an embodiment, the pyrazole carboxamide class of succinate dehydrogenase inhibitor fungicide may be selected from benzovindiflupyr, bixafen, fluxapyroxad, furametpyr, isopyrazam, penflufen, penthiopyrad, 3-difluoromethyl-N-(7-fluoro-1,1,3-trimethyl-4-indanyl)-1-methyl-4-pyrazolecarboxamide and sedaxane.

Benzovindiflupyr has the chemical name N-[(1RS,4SR)-9-(dichloromethylene)-1,2,3,4-tetrahydro-1,4-methanonaphthalen-5-yl]-3-(difluoromethyl)-1-methylpyrazole-4-carboxamide and has the structure:

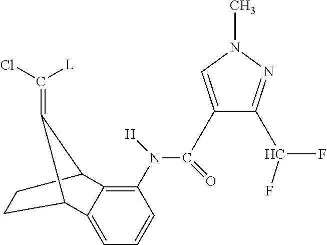

Bixafen has the chemical name N-(3′,4′-dichloro-5-fluorobiphenyl-2-yl)-3-(difluoromethyl)-1-methylpyrazole-4-carboxamide and the structure:

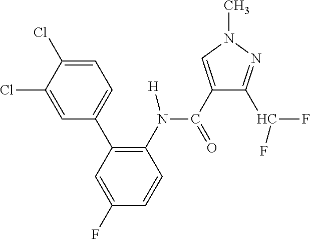 [SMILES: Cn1cc(C(=O)Nc2ccc(F)cc2-c2ccc(Cl)c(Cl)c2)c(C(F)F)n1]

Fluxapyroxad has the chemical name 3-(difluoromethyl)-1-methyl-N-(3′,4′,5′-trifluorobiphenyl-2-yl)pyrazole-4-carboxamide and has the structure:

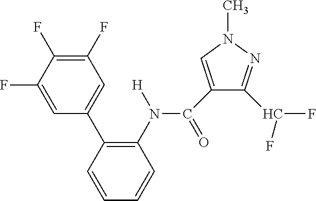 [SMILES: Cn1cc(C(=O)Nc2ccccc2-c2cc(F)c(F)c(F)c2)c(C(F)F)n1]

Furametpyr has the chemical name (RS)-5-chloro-N-(1,3-dihydro-1,1,3-trimethylisobenzofuran-4-yl)-1,3-dimethylpyrazole-4-carboxamide and has the structure:

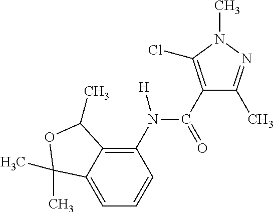

Isopyrazam is a mixture of 2 isomers 3-(difluoromethyl)-1-methyl-N-[(1RS,4SR,9RS)-1,2,3,4-tetrahydro-9-isopropyl-1,4-methanonaphthalen-5-yl]pyrazole-4-carboxamide and 2 aisomers 3-(difluoromethyl)-1-methyl-N-[(1RS,4SR,9SR)-1,2,3,4-tetrahydro-9-isopropyl-1,4-methanonaphthalen-5-yl]pyrazole-4-carboxamide and its tautomer's have the structure:

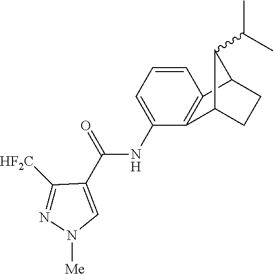

Penflufen has the chemical name N-[2-(1,3-dimethylbutyl)phenyl]-5-fluoro-1,3-dimethyl-1H-pyrazole-4-carboxamide, and has the following structure:

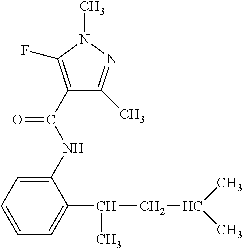 [SMILES: Cc1nn(C)c(F)c1C(=O)Nc1ccccc1C(C)CC(C)C]

Penthiopyrad has the chemical name (RS)-N-[2-(1,3-dimethylbutyl)-3-thienyl]-1-methyl-3-(trifluoromethyl)pyrazole-4-carboxamide, and has the following structure:

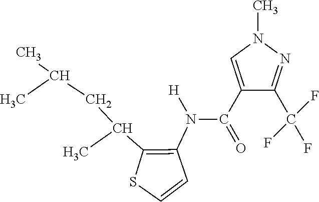 [SMILES: CC(C)CC(C)c1sccc1NC(=O)c1cn(C)nc1C(F)(F)F]

Sedaxane is a mixture of 2 cis-isomers 2′-[(1RS,2RS)-1,1′-bicycloprop-2-yl]-3-(difluoromethyl)-1-methylpyrazole-4-carboxanilide and 2 trans-isomers 2′-[(1RS,2SR)-1,1′-bicycloprop-2-yl]-3-(difluoromethyl)-1-methylpyrazole-4-carboxanilide, and its tautomers have the structure:

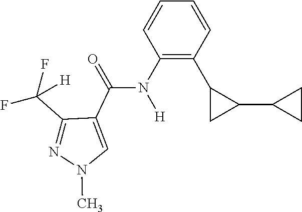 [SMILES: Cn1cc(C(=O)Nc2ccccc2C2CC2C2CC2)c(C(F)F)n1]

Fluindapyr is 3-(difluoromethyl)-N-[(3RS)-7-fluoro-2,3-dihydro-1,1,3-trimethyl-1H-inden-4-yl]-1-methyl-1H-pyrazole-4-carboxamide having following structure:

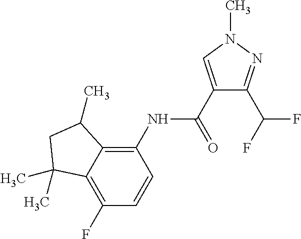 [SMILES: CC1CC(C)(C)c2c(F)ccc(NC(=O)c3cn(C)nc3C(F)F)c21]

Inpyrfluxam

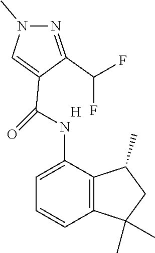

In an embodiment, the succinate dehydrogenase inhibitor fungicide may be selected from the group consisting of benodanil, flutolanil, mepronil, isofetamid, fluopyram, fenfuram, carboxin, oxycarboxin, thifluzamide, pydiflumetofen; isoflucypram, pyraziflumid, isofetamid and boscalid.

In an embodiment, the combinations of the present invention comprise at least two demethylation inhibitors.

In an embodiment, at least two demethylation Inhibitor (DMI) fungicides of the present invention may be selected from azaconazole, bitertanol, bromuconazole, cyproconazole, Difenconazole, diniconazole, epoxiconazole, etaconazole, fenbuconazole, fluquinconazole, flusilazole, flutriafol, hexaconazole, imibenconazole, ipconazole, mefentrifluconazole, metconazole, myclobutanil, penconazole, propiconazole, simeconazole, tebuconazole, tetraconazole, triadimefon, triadimenol, triticonazole, prothioconazole or combination thereof.

In an embodiment, the combinations of the present invention comprise at least two quinone outside inhibitors.

In an embodiment, at least two Quinone outside Inhibitors (QoI) fungicides of the present invention may be selected from azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimoxystrobin, fenaminstrobin, metominostrobin, orysastrobin, famoxadone, fluoxastrobin, fenamidone, or pyribencarb.

In an embodiment of the combinations of the present invention, the preferred succinate dehydrogenase inhibitor fungicide may be benzovindiflupyr, bixafen, fluindapyr, fluxapyroxad, furametpyr, inpyrfluxam, isopyrazam, penflufen, penthiopyrad, sedaxane and boscalid.

In an embodiment, the combinations of the present invention comprise at least one demethylation inhibitor and at least one quinone outside inhibitor apart from the succinate dehydrogenase inhibitor fungicide.

In an embodiment, the combination of the invention is free from any other fungicide apart from these fungicides. In this embodiment, the fungicidal combination of the invention is a triple combination of fungicides consisting of these three fungicides described hereinabove in any of the embodiments.

In any aspect or embodiment described hereinbelow, the phrase comprising may be replaced by the phrases “consisting of” or “consisting essentially of” or “consisting substantially of”. In these aspects or embodiment, the combination or composition described includes or comprises or consists of or consists essentially of or consists substantially of the specific components recited therein, to the exclusion of other fungicides or insecticide or herbicides or plant growth promoting agents or adjuvants or excipients not specifically recited therein.

In the exemplary combinations tabulated below, the term “Fungicide A” means at least one, and preferably individually each one of the fungicides selected from Isopyrazam (A1), Fluindapyr (A2), Boscalid (A3), Benzovindiflupyr (A4), Bixafen (A5), Fluxapyroxad (A6), Furametpyr (A7), Inpyrfluxam (A8), Penflufen (A9), Penthiopyrad (A10), Sedaxane (A11) as being specifically combined herein with the remaining fungicides.

In the exemplary combinations tabulated below, the term “Fungicide B” means at least one, and Cyproconazole (B1), Difenconazole (B2), Hexaconazole (B3), Tebuconazole (B4), Tetraconazole (B5), Prothioconazole (B6) and Epoxiconazole (B7); Azoxystrobin (B8), Picoxystrobin (B9), Pyraclostrobin (B10), Trifloxystrobin (B11), Fluoxastrobin (B12), Mandestrobin (B13) and Kresoxim-methyl(B14) as being specifically combined herein with the remaining fungicides.

In the exemplary combinations tabulated below, the term “Fungicide C” means at least one, and preferably individually each one of the fungicides selected from Cyproconazole (C1), Difenconazole (C2), Hexaconazole (C3), Tebuconazole (C4), Tetraconazole (C5), Prothioconazole (C6) Epoxiconazole (C7) Azoxystrobin (C8), Picoxystrobin (C9), Pyraclostrobin (C10), Trifloxystrobin (C11), Fluoxastrobin (C12), Mandestrobin (C13), Kresoxim-methyl (C14).

| Sr. No | Fungicide A | Fungicide B | Fungicide C |
|---|---|---|---|
| 1. | Isopyrazam, | Cyproconazole | Difenconazole |
| 2. | Isopyrazam, | Hexaconazole | Difenconazole |
| 3. | Isopyrazam, | Tebuconazole | Difenconazole |
| 4. | Isopyrazam, | Tetraconazole | Difenconazole |
| 5. | Isopyrazam, | Prothioconazole | Difenconazole |
| 6. | Isopyrazam, | Epoxiconazole | Difenconazole |
| 7. | Isopyrazam, | Cyproconazole | Hexaconazole |
| 8. | Isopyrazam, | Difenconazole | Hexaconazole |
| 9. | Isopyrazam, | Tebuconazole | Hexaconazole |
| 10. | Isopyrazam, | Tetraconazole | Hexaconazole |
| 11. | Isopyrazam, | Prothioconazole | Hexaconazole |
| 12. | Isopyrazam, | Epoxiconazole | Hexaconazole |
| 13. | Isopyrazam, | Cyproconazole | Tebuconazole |
| 14. | Isopyrazam, | Difenconazole | Tebuconazole |
| 15. | Isopyrazam, | Hexaconazole | Tebuconazole |
| 16. | Isopyrazam, | Tetraconazole | Tebuconazole |
| 17. | Isopyrazam, | Prothioconazole | Tebuconazole |
| 18. | Isopyrazam, | Epoxiconazole | Tebuconazole |
| 19. | Isopyrazam, | Cyproconazole | Tetraconazole |
| 20. | Isopyrazam, | Difenconazole | Tetraconazole |
| 21. | Isopyrazam, | Hexaconazole | Tetraconazole |
| 22. | Isopyrazam, | Tebuconazole | Tetraconazole |
| 23. | Isopyrazam, | Prothioconazole | Tetraconazole |
| 24. | Isopyrazam, | Epoxiconazole | Tetraconazole |
| 25. | Isopyrazam, | Cyproconazole | Prothioconazole |
| 26. | Isopyrazam, | Difenconazole | Prothioconazole |
| 27. | Isopyrazam, | Hexaconazole | Prothioconazole |
| 28. | Isopyrazam, | Tebuconazole | Prothioconazole |
| 29. | Isopyrazam, | Tetraconazole | Prothioconazole |
| 30. | Isopyrazam, | Epoxiconazole | Prothioconazole |
| 31. | Isopyrazam, | Cyproconazole | Epoxiconazole |
| 32. | Isopyrazam, | Difenconazole | Epoxiconazole |
| 33. | Isopyrazam, | Hexaconazole | Epoxiconazole |
| 34. | Isopyrazam, | Tebuconazole | Epoxiconazole |
| 35. | Isopyrazam, | Tetraconazole | Epoxiconazole |
| 36. | Isopyrazam, | Prothioconazole | Epoxiconazole |
| 37. | Isopyrazam, | Epoxiconazole | Cyproconazole |
| 38. | Isopyrazam, | Difenconazole | Cyproconazole |
| 39. | Isopyrazam, | Hexaconazole | Cyproconazole |
| 40. | Isopyrazam, | Tebuconazole | Cyproconazole |
| 41. | Isopyrazam, | Tetraconazole | Cyproconazole |
| 42. | Isopyrazam, | Prothioconazole | Cyproconazole |
| 43. | Fluindapyr | Cyproconazole | Difenconazole |
| 44. | Fluindapyr | Hexaconazole | Difenconazole |
| 45. | Fluindapyr | Tebuconazole | Difenconazole |
| 46. | Fluindapyr | Tetraconazole | Difenconazole |
| 47. | Fluindapyr | Prothioconazole | Difenconazole |
| 48. | Fluindapyr | Epoxiconazole | Difenconazole |
| 49. | Fluindapyr | Cyproconazole | Hexaconazole |
| 50. | Fluindapyr | Difenconazole | Hexaconazole |
| 51. | Fluindapyr | Tebuconazole | Hexaconazole |
| 52. | Fluindapyr | Tetraconazole | Hexaconazole |
| 53. | Fluindapyr | Prothioconazole | Hexaconazole |
| 54. | Fluindapyr | Epoxiconazole | Hexaconazole |
| 55. | Fluindapyr | Cyproconazole | Tebuconazole |
| 56. | Fluindapyr | Difenconazole | Tebuconazole |
| 57. | Fluindapyr | Hexaconazole | Tebuconazole |
| 58. | Fluindapyr | Tetraconazole | Tebuconazole |
| 59. | Fluindapyr | Prothioconazole | Tebuconazole |
| 60. | Fluindapyr | Epoxiconazole | Tebuconazole |
| 61. | Fluindapyr | Cyproconazole | Tetraconazole |
| 62. | Fluindapyr | Difenconazole | Tetraconazole |
| 63. | Fluindapyr | Hexaconazole | Tetraconazole |
| 64. | Fluindapyr | Tebuconazole | Tetraconazole |
| 65. | Fluindapyr | Prothioconazole | Tetraconazole |
| 66. | Fluindapyr | Epoxiconazole | Tetraconazole |
| 67. | Fluindapyr | Cyproconazole | Prothioconazole |
| 68. | Fluindapyr | Difenconazole | Prothioconazole |
| 69. | Fluindapyr | Hexaconazole | Prothioconazole |
| 70. | Fluindapyr | Tebuconazole | Prothioconazole |
| 71. | Fluindapyr | Tetraconazole | Prothioconazole |
| 72. | Fluindapyr | Epoxiconazole | Prothioconazole |
| 73. | Fluindapyr | Cyproconazole | Epoxiconazole |
| 74. | Fluindapyr | Difenconazole | Epoxiconazole |
| 75. | Fluindapyr | Hexaconazole | Epoxiconazole |
| 76. | Fluindapyr | Tebuconazole | Epoxiconazole |
| 77. | Fluindapyr | Tetraconazole | Epoxiconazole |
| 78. | Fluindapyr | Prothioconazole | Epoxiconazole |
| 79. | Fluindapyr | Epoxiconazole | Cyproconazole |
| 80. | Fluindapyr | Difenconazole | Cyproconazole |
| 81. | Fluindapyr | Hexaconazole | Cyproconazole |
| 82. | Fluindapyr | Tebuconazole | Cyproconazole |
| 83. | Fluindapyr | Tetraconazole | Cyproconazole |
| 84. | Fluindapyr | Prothioconazole | Cyproconazole |
| 85. | Boscalid | Cyproconazole | Difenconazole |
| 86. | Boscalid | Hexaconazole | Difenconazole |
| 87. | Boscalid | Tebuconazole | Difenconazole |
| 88. | Boscalid | Tetraconazole | Difenconazole |
| 89. | Boscalid | Prothioconazole | Difenconazole |
| 90. | Boscalid | Epoxiconazole | Difenconazole |
| 91. | Boscalid | Cyproconazole | Hexaconazole |
| 92. | Boscalid | Difenconazole | Hexaconazole |
| 93. | Boscalid | Tebuconazole | Hexaconazole |
| 94. | Boscalid | Tetraconazole | Hexaconazole |
| 95. | Boscalid | Prothioconazole | Hexaconazole |
| 96. | Boscalid | Epoxiconazole | Hexaconazole |
| 97. | Boscalid | Cyproconazole | Tebuconazole |
| 98. | Boscalid | Difenconazole | Tebuconazole |
| 99. | Boscalid | Hexaconazole | Tebuconazole |
| 100. | Boscalid | Tetraconazole | Tebuconazole |
| 101. | Boscalid | Prothioconazole | Tebuconazole |
| 102. | Boscalid | Epoxiconazole | Tebuconazole |
| 103. | Boscalid | Cyproconazole | Tetraconazole |
| 104. | Boscalid | Difenconazole | Tetraconazole |
| 105. | Boscalid | Hexaconazole | Tetraconazole |
| 106. | Boscalid | Tebuconazole | Tetraconazole |
| 107. | Boscalid | Prothioconazole | Tetraconazole |
| 108. | Boscalid | Epoxiconazole | Tetraconazole |
| 109. | Boscalid | Cyproconazole | Prothioconazole |
| 110. | Boscalid | Difenconazole | Prothioconazole |
| 111. | Boscalid | Hexaconazole | Prothioconazole |
| 112. | Boscalid | Tebuconazole | Prothioconazole |
| 113. | Boscalid | Tetraconazole | Prothioconazole |
| 114. | Boscalid | Epoxiconazole | Prothioconazole |
| 115. | Boscalid | Cyproconazole | Epoxiconazole |
| 116. | Boscalid | Difenconazole | Epoxiconazole |
| 117. | Boscalid | Hexaconazole | Epoxiconazole |
| 118. | Boscalid | Tebuconazole | Epoxiconazole |
| 119. | Boscalid | Tetraconazole | Epoxiconazole |
| 120. | Boscalid | Prothioconazole | Epoxiconazole |
| 121. | Boscalid | Epoxiconazole | Cyproconazole |
| 122. | Boscalid | Difenconazole | Cyproconazole |
| 123. | Boscalid | Hexaconazole | Cyproconazole |
| 124. | Boscalid | Tebuconazole | Cyproconazole |
| 125. | Boscalid | Tetraconazole | Cyproconazole |
| 126. | Boscalid | Prothioconazole | Cyproconazole |
| 127. | Benzovindiflupyr | Cyproconazole | Difenconazole |
| 128. | Benzovindiflupyr | Hexaconazole | Difenconazole |
| 129. | Benzovindiflupyr | Tebuconazole | Difenconazole |
| 130. | Benzovindiflupyr | Tetraconazole | Difenconazole |
| 131. | Benzovindiflupyr | Prothioconazole | Difenconazole |
| 132. | Benzovindiflupyr | Epoxiconazole | Difenconazole |
| 133. | Benzovindiflupyr | Cyproconazole | Hexaconazole |
| 134. | Benzovindiflupyr | Difenconazole | Hexaconazole |
| 135. | Benzovindiflupyr | Tebuconazole | Hexaconazole |
| 136. | Benzovindiflupyr | Tetraconazole | Hexaconazole |
| 137. | Benzovindiflupyr | Prothioconazole | Hexaconazole |
| 138. | Benzovindiflupyr | Epoxiconazole | Hexaconazole |
| 139. | Benzovindiflupyr | Cyproconazole | Tebuconazole |
| 140. | Benzovindiflupyr | Difenconazole | Tebuconazole |
| 141. | Benzovindiflupyr | Hexaconazole | Tebuconazole |
| 142. | Benzovindiflupyr | Tetraconazole | Tebuconazole |
| 143. | Benzovindiflupyr | Prothioconazole | Tebuconazole |
| 144. | Benzovindiflupyr | Epoxiconazole | Tebuconazole |
| 145. | Benzovindiflupyr | Cyproconazole | Tetraconazole |
| 146. | Benzovindiflupyr | Difenconazole | Tetraconazole |
| 147. | Benzovindiflupyr | Hexaconazole | Tetraconazole |
| 148. | Benzovindiflupyr | Tebuconazole | Tetraconazole |
| 149. | Benzovindiflupyr | Prothioconazole | Tetraconazole |
| 150. | Benzovindiflupyr | Epoxiconazole | Tetraconazole |
| 151. | Benzovindiflupyr | Cyproconazole | Prothioconazole |
| 152. | Benzovindiflupyr | Difenconazole | Prothioconazole |
| 153. | Benzovindiflupyr | Hexaconazole | Prothioconazole |
| 154. | Benzovindiflupyr | Tebuconazole | Prothioconazole |
| 155. | Benzovindiflupyr | Tetraconazole | Prothioconazole |
| 156. | Benzovindiflupyr | Epoxiconazole | Prothioconazole |
| 157. | Benzovindiflupyr | Cyproconazole | Epoxiconazole |
| 158. | Benzovindiflupyr | Difenconazole | Epoxiconazole |
| 159. | Benzovindiflupyr | Hexaconazole | Epoxiconazole |
| 160. | Benzovindiflupyr | Tebuconazole | Epoxiconazole |
| 161. | Benzovindiflupyr | Tetraconazole | Epoxiconazole |
| 162. | Benzovindiflupyr | Prothioconazole | Epoxiconazole |
| 163. | Benzovindiflupyr | Epoxiconazole | Cyproconazole |
| 164. | Benzovindiflupyr | Difenconazole | Cyproconazole |
| 165. | Benzovindiflupyr | Hexaconazole | Cyproconazole |
| 166. | Benzovindiflupyr | Tebuconazole | Cyproconazole |
| 167. | Benzovindiflupyr | Tetraconazole | Cyproconazole |
| 168. | Benzovindiflupyr | Prothioconazole | Cyproconazole |
| 169. | Bixafen | Cyproconazole | Difenconazole |
| 170. | Bixafen | Hexaconazole | Difenconazole |
| 171. | Bixafen | Tebuconazole | Difenconazole |
| 172. | Bixafen | Tetraconazole | Difenconazole |
| 173. | Bixafen | Prothioconazole | Difenconazole |
| 174. | Bixafen | Epoxiconazole | Difenconazole |
| 175. | Bixafen | Cyproconazole | Hexaconazole |
| 176. | Bixafen | Difenconazole | Hexaconazole |
| 177. | Bixafen | Tebuconazole | Hexaconazole |
| 178. | Bixafen | Tetraconazole | Hexaconazole |
| 179. | Bixafen | Prothioconazole | Hexaconazole |
| 180. | Bixafen | Epoxiconazole | Hexaconazole |
| 181. | Bixafen | Cyproconazole | Tebuconazole |
| 182. | Bixafen | Difenconazole | Tebuconazole |
| 183. | Bixafen | Hexaconazole | Tebuconazole |
| 184. | Bixafen | Tetraconazole | Tebuconazole |
| 185. | Bixafen | Prothioconazole | Tebuconazole |
| 186. | Bixafen | Epoxiconazole | Tebuconazole |
| 187. | Bixafen | Cyproconazole | Tetraconazole |
| 188. | Bixafen | Difenconazole | Tetraconazole |
| 189. | Bixafen | Hexaconazole | Tetraconazole |
| 190. | Bixafen | Tebuconazole | Tetraconazole |
| 191. | Bixafen | Prothioconazole | Tetraconazole |
| 192. | Bixafen | Epoxiconazole | Tetraconazole |
| 193. | Bixafen | Cyproconazole | Prothioconazole |
| 194. | Bixafen | Difenconazole | Prothioconazole |
| 195. | Bixafen | Hexaconazole | Prothioconazole |
| 196. | Bixafen | Tebuconazole | Prothioconazole |
| 197. | Bixafen | Tetraconazole | Prothioconazole |
| 198. | Bixafen | Epoxiconazole | Prothioconazole |
| 199. | Bixafen | Cyproconazole | Epoxiconazole |
| 200. | Bixafen | Difenconazole | Epoxiconazole |
| 201. | Bixafen | Hexaconazole | Epoxiconazole |
| 202. | Bixafen | Tebuconazole | Epoxiconazole |
| 203. | Bixafen | Tetraconazole | Epoxiconazole |
| 204. | Bixafen | Prothioconazole | Epoxiconazole |
| 205. | Bixafen | Epoxiconazole | Cyproconazole |
| 206. | Bixafen | Difenconazole | Cyproconazole |
| 207. | Bixafen | Hexaconazole | Cyproconazole |
| 208. | Bixafen | Tebuconazole | Cyproconazole |
| 209. | Bixafen | Tetraconazole | Cyproconazole |
| 210. | Bixafen | Prothioconazole | Cyproconazole |
| 211. | Fluxapyroxad | Cyproconazole | Difenconazole |
| 212. | Fluxapyroxad | Hexaconazole | Difenconazole |
| 213. | Fluxapyroxad | Tebuconazole | Difenconazole |
| 214. | Fluxapyroxad | Tetraconazole | Difenconazole |
| 215. | Fluxapyroxad | Prothioconazole | Difenconazole |
| 216. | Fluxapyroxad | Epoxiconazole | Difenconazole |
| 217. | Fluxapyroxad | Cyproconazole | Hexaconazole |
| 218. | Fluxapyroxad | Difenconazole | Hexaconazole |
| 219. | Fluxapyroxad | Tebuconazole | Hexaconazole |
| 220. | Fluxapyroxad | Tetraconazole | Hexaconazole |
| 221. | Fluxapyroxad | Prothioconazole | Hexaconazole |
| 222. | Fluxapyroxad | Epoxiconazole | Hexaconazole |
| 223. | Fluxapyroxad | Cyproconazole | Tebuconazole |
| 224. | Fluxapyroxad | Difenconazole | Tebuconazole |
| 225. | Fluxapyroxad | Hexaconazole | Tebuconazole |
| 226. | Fluxapyroxad | Tetraconazole | Tebuconazole |
| 227. | Fluxapyroxad | Prothioconazole | Tebuconazole |
| 228. | Fluxapyroxad | Epoxiconazole | Tebuconazole |
| 229. | Fluxapyroxad | Cyproconazole | Tetraconazole |
| 230. | Fluxapyroxad | Difenconazole | Tetraconazole |
| 231. | Fluxapyroxad | Hexaconazole | Tetraconazole |
| 232. | Fluxapyroxad | Tebuconazole | Tetraconazole |
| 233. | Fluxapyroxad | Prothioconazole | Tetraconazole |
| 234. | Fluxapyroxad | Epoxiconazole | Tetraconazole |
| 235. | Fluxapyroxad | Cyproconazole | Prothioconazole |
| 236. | Fluxapyroxad | Difenconazole | Prothioconazole |
| 237. | Fluxapyroxad | Hexaconazole | Prothioconazole |
| 238. | Fluxapyroxad | Tebuconazole | Prothioconazole |
| 239. | Fluxapyroxad | Tetraconazole | Prothioconazole |
| 240. | Fluxapyroxad | Epoxiconazole | Prothioconazole |
| 241. | Fluxapyroxad | Cyproconazole | Epoxiconazole |
| 242. | Fluxapyroxad | Difenconazole | Epoxiconazole |
| 243. | Fluxapyroxad | Hexaconazole | Epoxiconazole |
| 244. | Fluxapyroxad | Tebuconazole | Epoxiconazole |
| 245. | Fluxapyroxad | Tetraconazole | Epoxiconazole |
| 246. | Fluxapyroxad | Prothioconazole | Epoxiconazole |
| 247. | Fluxapyroxad | Epoxiconazole | Cyproconazole |
| 248. | Fluxapyroxad | Difenconazole | Cyproconazole |
| 249. | Fluxapyroxad | Hexaconazole | Cyproconazole |
| 250. | Fluxapyroxad | Tebuconazole | Cyproconazole |
| 251. | Fluxapyroxad | Tetraconazole | Cyproconazole |
| 252. | Fluxapyroxad | Prothioconazole | Cyproconazole |
| 253. | Furametpyr | Cyproconazole | Difenconazole |
| 254. | Furametpyr | Hexaconazole | Difenconazole |
| 255. | Furametpyr | Tebuconazole | Difenconazole |
| 256. | Furametpyr | Tetraconazole | Difenconazole |
| 257. | Furametpyr | Prothioconazole | Difenconazole |
| 258. | Furametpyr | Epoxiconazole | Difenconazole |
| 259. | Furametpyr | Cyproconazole | Hexaconazole |
| 260. | Furametpyr | Difenconazole | Hexaconazole |
| 261. | Furametpyr | Tebuconazole | Hexaconazole |
| 262. | Furametpyr | Tetraconazole | Hexaconazole |
| 263. | Furametpyr | Prothioconazole | Hexaconazole |
| 264. | Furametpyr | Epoxiconazole | Hexaconazole |
| 265. | Furametpyr | Cyproconazole | Tebuconazole |
| 266. | Furametpyr | Difenconazole | Tebuconazole |
| 267. | Furametpyr | Hexaconazole | Tebuconazole |
| 268. | Furametpyr | Tetraconazole | Tebuconazole |
| 269. | Furametpyr | Prothioconazole | Tebuconazole |
| 270. | Furametpyr | Epoxiconazole | Tebuconazole |
| 271. | Furametpyr | Cyproconazole | Tetraconazole |
| 272. | Furametpyr | Difenconazole | Tetraconazole |
| 273. | Furametpyr | Hexaconazole | Tetraconazole |
| 274. | Furametpyr | Tebuconazole | Tetraconazole |
| 275. | Furametpyr | Prothioconazole | Tetraconazole |
| 276. | Furametpyr | Epoxiconazole | Tetraconazole |
| 277. | Furametpyr | Cyproconazole | Prothioconazole |
| 278. | Furametpyr | Difenconazole | Prothioconazole |
| 279. | Furametpyr | Hexaconazole | Prothioconazole |
| 280. | Furametpyr | Tebuconazole | Prothioconazole |
| 281. | Furametpyr | Tetraconazole | Prothioconazole |
| 282. | Furametpyr | Epoxiconazole | Prothioconazole |
| 283. | Furametpyr | Cyproconazole | Epoxiconazole |
| 284. | Furametpyr | Difenconazole | Epoxiconazole |
| 285. | Furametpyr | Hexaconazole | Epoxiconazole |
| 286. | Furametpyr | Tebuconazole | Epoxiconazole |
| 287. | Furametpyr | Tetraconazole | Epoxiconazole |
| 288. | Furametpyr | Prothioconazole | Epoxiconazole |
| 289. | Furametpyr | Epoxiconazole | Cyproconazole |
| 290. | Furametpyr | Difenconazole | Cyproconazole |
| 291. | Furametpyr | Hexaconazole | Cyproconazole |
| 292. | Furametpyr | Tebuconazole | Cyproconazole |
| 293. | Furametpyr | Tetraconazole | Cyproconazole |
| 294. | Furametpyr | Prothioconazole | Cyproconazole |
| 295. | Inpyrfluxam | Cyproconazole | Difenconazole |
| 296. | Inpyrfluxam | Hexaconazole | Difenconazole |
| 297. | Inpyrfluxam | Tebuconazole | Difenconazole |
| 298. | Inpyrfluxam | Tetraconazole | Difenconazole |
| 299. | Inpyrfluxam | Prothioconazole | Difenconazole |
| 300. | Inpyrfluxam | Epoxiconazole | Difenconazole |
| 301. | Inpyrfluxam | Cyproconazole | Hexaconazole |
| 302. | Inpyrfluxam | Difenconazole | Hexaconazole |
| 303. | Inpyrfluxam | Tebuconazole | Hexaconazole |
| 304. | Inpyrfluxam | Tetraconazole | Hexaconazole |
| 305. | Inpyrfluxam | Prothioconazole | Hexaconazole |
| 306. | Inpyrfluxam | Epoxiconazole | Hexaconazole |
| 307. | Inpyrfluxam | Cyproconazole | Tebuconazole |
| 308. | Inpyrfluxam | Difenconazole | Tebuconazole |
| 309. | Inpyrfluxam | Hexaconazole | Tebuconazole |
| 310. | Inpyrfluxam | Tetraconazole | Tebuconazole |
| 311. | Inpyrfluxam | Prothioconazole | Tebuconazole |
| 312. | Inpyrfluxam | Epoxiconazole | Tebuconazole |
| 313. | Inpyrfluxam | Cyproconazole | Tetraconazole |
| 314. | Inpyrfluxam | Difenconazole | Tetraconazole |
| 315. | Inpyrfluxam | Hexaconazole | Tetraconazole |
| 316. | Inpyrfluxam | Tebuconazole | Tetraconazole |
| 317. | Inpyrfluxam | Prothioconazole | Tetraconazole |
| 318. | Inpyrfluxam | Epoxiconazole | Tetraconazole |
| 319. | Inpyrfluxam | Cyproconazole | Prothioconazole |
| 320. | Inpyrfluxam | Difenconazole | Prothioconazole |
| 321. | Inpyrfluxam | Hexaconazole | Prothioconazole |
| 322. | Inpyrfluxam | Tebuconazole | Prothioconazole |
| 323. | Inpyrfluxam | Tetraconazole | Prothioconazole |
| 324. | Inpyrfluxam | Epoxiconazole | Prothioconazole |
| 325. | Inpyrfluxam | Cyproconazole | Epoxiconazole |
| 326. | Inpyrfluxam | Difenconazole | Epoxiconazole |
| 327. | Inpyrfluxam | Hexaconazole | Epoxiconazole |
| 328. | Inpyrfluxam | Tebuconazole | Epoxiconazole |
| 329. | Inpyrfluxam | Tetraconazole | Epoxiconazole |
| 330. | Inpyrfluxam | Prothioconazole | Epoxiconazole |
| 331. | Inpyrfluxam | Epoxiconazole | Cyproconazole |
| 332. | Inpyrfluxam | Difenconazole | Cyproconazole |
| 333. | Inpyrfluxam | Hexaconazole | Cyproconazole |
| 334. | Inpyrfluxam | Tebuconazole | Cyproconazole |
| 335. | Inpyrfluxam | Tetraconazole | Cyproconazole |
| 336. | Inpyrfluxam | Prothioconazole | Cyproconazole |
| 337. | Penflufen | Cyproconazole | Difenconazole |
| 338. | Penflufen | Hexaconazole | Difenconazole |
| 339. | Penflufen | Tebuconazole | Difenconazole |
| 340. | Penflufen | Tetraconazole | Difenconazole |
| 341. | Penflufen | Prothioconazole | Difenconazole |
| 342. | Penflufen | Epoxiconazole | Difenconazole |
| 343. | Penflufen | Cyproconazole | Hexaconazole |
| 344. | Penflufen | Difenconazole | Hexaconazole |
| 345. | Penflufen | Tebuconazole | Hexaconazole |
| 346. | Penflufen | Tetraconazole | Hexaconazole |
| 347. | Penflufen | Prothioconazole | Hexaconazole |
| 348. | Penflufen | Epoxiconazole | Hexaconazole |
| 349. | Penflufen | Cyproconazole | Tebuconazole |
| 350. | Penflufen | Difenconazole | Tebuconazole |
| 351. | Penflufen | Hexaconazole | Tebuconazole |
| 352. | Penflufen | Tetraconazole | Tebuconazole |
| 353. | Penflufen | Prothioconazole | Tebuconazole |
| 354. | Penflufen | Epoxiconazole | Tebuconazole |
| 355. | Penflufen | Cyproconazole | Tetraconazole |
| 356. | Penflufen | Difenconazole | Tetraconazole |
| 357. | Penflufen | Hexaconazole | Tetraconazole |
| 358. | Penflufen | Tebuconazole | Tetraconazole |
| 359. | Penflufen | Prothioconazole | Tetraconazole |
| 360. | Penflufen | Epoxiconazole | Tetraconazole |
| 361. | Penflufen | Cyproconazole | Prothioconazole |
| 362. | Penflufen | Difenconazole | Prothioconazole |
| 363. | Penflufen | Hexaconazole | Prothioconazole |
| 364. | Penflufen | Tebuconazole | Prothioconazole |
| 365. | Penflufen | Tetraconazole | Prothioconazole |
| 366. | Penflufen | Epoxiconazole | Prothioconazole |
| 367. | Penflufen | Cyproconazole | Epoxiconazole |
| 368. | Penflufen | Difenconazole | Epoxiconazole |
| 369. | Penflufen | Hexaconazole | Epoxiconazole |
| 370. | Penflufen | Tebuconazole | Epoxiconazole |
| 371. | Penflufen | Tetraconazole | Epoxiconazole |
| 372. | Penflufen | Prothioconazole | Epoxiconazole |
| 373. | Penflufen | Epoxiconazole | Cyproconazole |
| 374. | Penflufen | Difenconazole | Cyproconazole |
| 375. | Penflufen | Hexaconazole | Cyproconazole |
| 376. | Penflufen | Tebuconazole | Cyproconazole |
| 377. | Penflufen | Tetraconazole | Cyproconazole |
| 378. | Penflufen | Prothioconazole | Cyproconazole |
| 379. | Penthiopyrad | Cyproconazole | Difenconazole |
| 380. | Penthiopyrad | Hexaconazole | Difenconazole |
| 381. | Penthiopyrad | Tebuconazole | Difenconazole |
| 382. | Penthiopyrad | Tetraconazole | Difenconazole |
| 383. | Penthiopyrad | Prothioconazole | Difenconazole |
| 384. | Penthiopyrad | Epoxiconazole | Difenconazole |
| 385. | Penthiopyrad | Cyproconazole | Hexaconazole |
| 386. | Penthiopyrad | Difenconazole | Hexaconazole |
| 387. | Penthiopyrad | Tebuconazole | Hexaconazole |
| 388. | Penthiopyrad | Tetraconazole | Hexaconazole |
| 389. | Penthiopyrad | Prothioconazole | Hexaconazole |
| 390. | Penthiopyrad | Epoxiconazole | Hexaconazole |
| 391. | Penthiopyrad | Cyproconazole | Tebuconazole |
| 392. | Penthiopyrad | Difenconazole | Tebuconazole |
| 393. | Penthiopyrad | Hexaconazole | Tebuconazole |
| 394. | Penthiopyrad | Tetraconazole | Tebuconazole |
| 395. | Penthiopyrad | Prothioconazole | Tebuconazole |
| 396. | Penthiopyrad | Epoxiconazole | Tebuconazole |
| 397. | Penthiopyrad | Cyproconazole | Tetraconazole |
| 398. | Penthiopyrad | Difenconazole | Tetraconazole |
| 399. | Penthiopyrad | Hexaconazole | Tetraconazole |
| 400. | Penthiopyrad | Tebuconazole | Tetraconazole |
| 401. | Penthiopyrad | Prothioconazole | Tetraconazole |
| 402. | Penthiopyrad | Epoxiconazole | Tetraconazole |
| 403. | Penthiopyrad | Cyproconazole | Prothioconazole |
| 404. | Penthiopyrad | Difenconazole | Prothioconazole |
| 405. | Penthiopyrad | Hexaconazole | Prothioconazole |
| 406. | Penthiopyrad | Tebuconazole | Prothioconazole |
| 407. | Penthiopyrad | Tetraconazole | Prothioconazole |
| 408. | Penthiopyrad | Epoxiconazole | Prothioconazole |
| 409. | Penthiopyrad | Cyproconazole | Epoxiconazole |
| 410. | Penthiopyrad | Difenconazole | Epoxiconazole |
| 411. | Penthiopyrad | Hexaconazole | Epoxiconazole |
| 412. | Penthiopyrad | Tebuconazole | Epoxiconazole |
| 413. | Penthiopyrad | Tetraconazole | Epoxiconazole |
| 414. | Penthiopyrad | Prothioconazole | Epoxiconazole |
| 415. | Penthiopyrad | Epoxiconazole | Cyproconazole |
| 416. | Penthiopyrad | Difenconazole | Cyproconazole |
| 417. | Penthiopyrad | Hexaconazole | Cyproconazole |
| 418. | Penthiopyrad | Tebuconazole | Cyproconazole |
| 419. | Penthiopyrad | Tetraconazole | Cyproconazole |
| 420. | Penthiopyrad | Prothioconazole | Cyproconazole |
| 421. | Sedaxane | Cyproconazole | Difenconazole |
| 422. | Sedaxane | Hexaconazole | Difenconazole |
| 423. | Sedaxane | Tebuconazole | Difenconazole |
| 424. | Sedaxane | Tetraconazole | Difenconazole |
| 425. | Sedaxane | Prothioconazole | Difenconazole |
| 426. | Sedaxane | Epoxiconazole | Difenconazole |
| 427. | Sedaxane | Cyproconazole | Hexaconazole |
| 428. | Sedaxane | Difenconazole | Hexaconazole |
| 429. | Sedaxane | Tebuconazole | Hexaconazole |
| 430. | Sedaxane | Tetraconazole | Hexaconazole |
| 431. | Sedaxane | Prothioconazole | Hexaconazole |
| 432. | Sedaxane | Epoxiconazole | Hexaconazole |
| 433. | Sedaxane | Cyproconazole | Tebuconazole |
| 434. | Sedaxane | Difenconazole | Tebuconazole |
| 435. | Sedaxane | Hexaconazole | Tebuconazole |
| 436. | Sedaxane | Tetraconazole | Tebuconazole |
| 437. | Sedaxane | Prothioconazole | Tebuconazole |
| 438. | Sedaxane | Epoxiconazole | Tebuconazole |
| 439. | Sedaxane | Cyproconazole | Tetraconazole |
| 440. | Sedaxane | Difenconazole | Tetraconazole |
| 441. | Sedaxane | Hexaconazole | Tetraconazole |
| 442. | Sedaxane | Tebuconazole | Tetraconazole |
| 443. | Sedaxane | Prothioconazole | Tetraconazole |
| 444. | Sedaxane | Epoxiconazole | Tetraconazole |
| 445. | Sedaxane | Cyproconazole | Prothioconazole |
| 446. | Sedaxane | Difenconazole | Prothioconazole |
| 447. | Sedaxane | Hexaconazole | Prothioconazole |
| 448. | Sedaxane | Tebuconazole | Prothioconazole |
| 449. | Sedaxane | Tetraconazole | Prothioconazole |
| 450. | Sedaxane | Epoxiconazole | Prothioconazole |
| 451. | Sedaxane | Cyproconazole | Epoxiconazole |
| 452. | Sedaxane | Difenconazole | Epoxiconazole |
| 453. | Sedaxane | Hexaconazole | Epoxiconazole |
| 454. | Sedaxane | Tebuconazole | Epoxiconazole |
| 455. | Sedaxane | Tetraconazole | Epoxiconazole |
| 456. | Sedaxane | Prothioconazole | Epoxiconazole |
| 457. | Sedaxane | Epoxiconazole | Cyproconazole |
| 458. | Sedaxane | Difenconazole | Cyproconazole |
| 459. | Sedaxane | Hexaconazole | Cyproconazole |
| 460. | Sedaxane | Tebuconazole | Cyproconazole |
| 461. | Sedaxane | Tetraconazole | Cyproconazole |
| 462. | Sedaxane | Prothioconazole | Cyproconazole |
| 463. | Isopyrazam, | Azoxystrobin | Kresoxim-methyl |
| 464. | Isopyrazam, | Picoxystrobin | Kresoxim-methyl |
| 465. | Isopyrazam, | Pyraclostrobin | Kresoxim-methyl |
| 466. | Isopyrazam, | Trifloxystrobin | Kresoxim-methyl |
| 467. | Isopyrazam, | Fluoxastrobin | Kresoxim-methyl |
| 468. | Isopyrazam, | Mandestrobin | Kresoxim-methyl |
| 469. | Isopyrazam, | Azoxystrobin | Mandestrobin |
| 470. | Isopyrazam, | Picoxystrobin | Mandestrobin |
| 471. | Isopyrazam, | Pyraclostrobin | Mandestrobin |
| 472. | Isopyrazam, | Trifloxystrobin | Mandestrobin |
| 473. | Isopyrazam, | Fluoxastrobin | Mandestrobin |
| 474. | Isopyrazam, | Kresoxim-methyl | Mandestrobin |
| 475. | Isopyrazam, | Azoxystrobin | Fluoxastrobin |
| 476. | Isopyrazam, | Picoxystrobin | Fluoxastrobin |
| 477. | Isopyrazam, | Pyraclostrobin | Fluoxastrobin |
| 478. | Isopyrazam, | Trifloxystrobin | Fluoxastrobin |
| 479. | Isopyrazam, | Mandestrobin | Fluoxastrobin |
| 480. | Isopyrazam, | Kresoxim-methyl | Fluoxastrobin |
| 481. | Isopyrazam, | Azoxystrobin | Trifloxystrobin |
| 482. | Isopyrazam, | Picoxystrobin | Trifloxystrobin |
| 483. | Isopyrazam, | Pyraclostrobin | Trifloxystrobin |
| 484. | Isopyrazam, | Fluoxastrobin | Trifloxystrobin |
| 485. | Isopyrazam, | Mandestrobin | Trifloxystrobin |
| 486. | Isopyrazam, | Kresoxim-methyl | Trifloxystrobin |
| 487. | Isopyrazam, | Azoxystrobin | Pyraclostrobin |
| 488. | Isopyrazam, | Picoxystrobin | Pyraclostrobin |
| 489. | Isopyrazam, | Trifloxystrobin | Pyraclostrobin |
| 490. | Isopyrazam, | Fluoxastrobin | Pyraclostrobin |
| 491. | Isopyrazam, | Mandestrobin | Pyraclostrobin |
| 492. | Isopyrazam, | Kresoxim-methyl | Pyraclostrobin |
| 493. | Isopyrazam, | Azoxystrobin | Picoxystrobin |
| 494. | Isopyrazam, | Pyraclostrobin | Picoxystrobin |
| 495. | Isopyrazam, | Trifloxystrobin | Picoxystrobin |
| 496. | Isopyrazam, | Fluoxastrobin | Picoxystrobin |
| 497. | Isopyrazam, | Mandestrobin | Picoxystrobin |
| 498. | Isopyrazam, | Kresoxim-methyl | Picoxystrobin |
| 499. | Isopyrazam, | Picoxystrobin | Azoxystrobin |
| 500. | Isopyrazam, | Pyraclostrobin | Azoxystrobin |
| 501. | Isopyrazam, | Trifloxystrobin | Azoxystrobin |
| 502. | Isopyrazam, | Fluoxastrobin | Azoxystrobin |
| 503. | Isopyrazam, | Mandestrobin | Azoxystrobin |
| 504. | Isopyrazam, | Kresoxim-methyl | Azoxystrobin |
| 505. | Fluindapyr | Azoxystrobin | Kresoxim-methyl |
| 506. | Fluindapyr | Picoxystrobin | Kresoxim-methyl |
| 507. | Fluindapyr | Pyraclostrobin | Kresoxim-methyl |
| 508. | Fluindapyr | Trifloxystrobin | Kresoxim-methyl |
| 509. | Fluindapyr | Fluoxastrobin | Kresoxim-methyl |
| 510. | Fluindapyr | Mandestrobin | Kresoxim-methyl |
| 511. | Fluindapyr | Azoxystrobin | Mandestrobin |
| 512. | Fluindapyr | Picoxystrobin | Mandestrobin |
| 513. | Fluindapyr | Pyraclostrobin | Mandestrobin |
| 514. | Fluindapyr | Trifloxystrobin | Mandestrobin |
| 515. | Fluindapyr | Fluoxastrobin | Mandestrobin |
| 516. | Fluindapyr | Kresoxim-methyl | Mandestrobin |
| 517. | Fluindapyr | Azoxystrobin | Fluoxastrobin |
| 518. | Fluindapyr | Picoxystrobin | Fluoxastrobin |
| 519. | Fluindapyr | Pyraclostrobin | Fluoxastrobin |
| 520. | Fluindapyr | Trifloxystrobin | Fluoxastrobin |
| 521. | Fluindapyr | Mandestrobin | Fluoxastrobin |
| 522. | Fluindapyr | Kresoxim-methyl | Fluoxastrobin |
| 523. | Fluindapyr | Azoxystrobin | Trifloxystrobin |
| 524. | Fluindapyr | Picoxystrobin | Trifloxystrobin |
| 525. | Fluindapyr | Pyraclostrobin | Trifloxystrobin |
| 526. | Fluindapyr | Fluoxastrobin | Trifloxystrobin |
| 527. | Fluindapyr | Mandestrobin | Trifloxystrobin |
| 528. | Fluindapyr | Kresoxim-methyl | Trifloxystrobin |
| 529. | Fluindapyr | Azoxystrobin | Pyraclostrobin |
| 530. | Fluindapyr | Picoxystrobin | Pyraclostrobin |
| 531. | Fluindapyr | Trifloxystrobin | Pyraclostrobin |
| 532. | Fluindapyr | Fluoxastrobin | Pyraclostrobin |
| 533. | Fluindapyr | Mandestrobin | Pyraclostrobin |
| 534. | Fluindapyr | Kresoxim-methyl | Pyraclostrobin |
| 535. | Fluindapyr | Azoxystrobin | Picoxystrobin |
| 536. | Fluindapyr | Pyraclostrobin | Picoxystrobin |
| 537. | Fluindapyr | Trifloxystrobin | Picoxystrobin |
| 538. | Fluindapyr | Fluoxastrobin | Picoxystrobin |
| 539. | Fluindapyr | Mandestrobin | Picoxystrobin |
| 540. | Fluindapyr | Kresoxim-methyl | Picoxystrobin |
| 541. | Fluindapyr | Picoxystrobin | Azoxystrobin |
| 542. | Fluindapyr | Pyraclostrobin | Azoxystrobin |
| 543. | Fluindapyr | Trifloxystrobin | Azoxystrobin |
| 544. | Fluindapyr | Fluoxastrobin | Azoxystrobin |
| 545. | Fluindapyr | Mandestrobin | Azoxystrobin |
| 546. | Fluindapyr | Kresoxim-methyl | Azoxystrobin |
| 547. | Boscalid | Azoxystrobin | Kresoxim-methyl |
| 548. | Boscalid | Picoxystrobin | Kresoxim-methyl |
| 549. | Boscalid | Pyraclostrobin | Kresoxim-methyl |
| 550. | Boscalid | Trifloxystrobin | Kresoxim-methyl |
| 551. | Boscalid | Fluoxastrobin | Kresoxim-methyl |
| 552. | Boscalid | Mandestrobin | Kresoxim-methyl |
| 553. | Boscalid | Azoxystrobin | Mandestrobin |
| 554. | Boscalid | Picoxystrobin | Mandestrobin |
| 555. | Boscalid | Pyraclostrobin | Mandestrobin |
| 556. | Boscalid | Trifloxystrobin | Mandestrobin |
| 557. | Boscalid | Fluoxastrobin | Mandestrobin |
| 558. | Boscalid | Kresoxim-methyl | Mandestrobin |
| 559. | Boscalid | Azoxystrobin | Fluoxastrobin |
| 560. | Boscalid | Picoxystrobin | Fluoxastrobin |
| 561. | Boscalid | Pyraclostrobin | Fluoxastrobin |
| 562. | Boscalid | Trifloxystrobin | Fluoxastrobin |
| 563. | Boscalid | Mandestrobin | Fluoxastrobin |
| 564. | Boscalid | Kresoxim-methyl | Fluoxastrobin |
| 565. | Boscalid | Azoxystrobin | Trifloxystrobin |
| 566. | Boscalid | Picoxystrobin | Trifloxystrobin |
| 567. | Boscalid | Pyraclostrobin | Trifloxystrobin |
| 568. | Boscalid | Fluoxastrobin | Trifloxystrobin |
| 569. | Boscalid | Mandestrobin | Trifloxystrobin |
| 570. | Boscalid | Kresoxim-methyl | Trifloxystrobin |
| 571. | Boscalid | Azoxystrobin | Pyraclostrobin |
| 572. | Boscalid | Picoxystrobin | Pyraclostrobin |
| 573. | Boscalid | Trifloxystrobin | Pyraclostrobin |
| 574. | Boscalid | Fluoxastrobin | Pyraclostrobin |
| 575. | Boscalid | Mandestrobin | Pyraclostrobin |
| 576. | Boscalid | Kresoxim-methyl | Pyraclostrobin |
| 577. | Boscalid | Azoxystrobin | Picoxystrobin |
| 578. | Boscalid | Pyraclostrobin | Picoxystrobin |
| 579. | Boscalid | Trifloxystrobin | Picoxystrobin |
| 580. | Boscalid | Fluoxastrobin | Picoxystrobin |
| 581. | Boscalid | Mandestrobin | Picoxystrobin |
| 582. | Boscalid | Kresoxim-methyl | Picoxystrobin |
| 583. | Boscalid | Picoxystrobin | Azoxystrobin |
| 584. | Boscalid | Pyraclostrobin | Azoxystrobin |
| 585. | Boscalid | Trifloxystrobin | Azoxystrobin |
| 586. | Boscalid | Fluoxastrobin | Azoxystrobin |
| 587. | Boscalid | Mandestrobin | Azoxystrobin |
| 588. | Boscalid | Kresoxim-methyl | Azoxystrobin |
| 589. | Benzovindiflupyr | Azoxystrobin | Kresoxim-methyl |
| 590. | Benzovindiflupyr | Picoxystrobin | Kresoxim-methyl |
| 591. | Benzovindiflupyr | Pyraclostrobin | Kresoxim-methyl |
| 592. | Benzovindiflupyr | Trifloxystrobin | Kresoxim-methyl |
| 593. | Benzovindiflupyr | Fluoxastrobin | Kresoxim-methyl |
| 594. | Benzovindiflupyr | Mandestrobin | Kresoxim-methyl |
| 595. | Benzovindiflupyr | Azoxystrobin | Mandestrobin |
| 596. | Benzovindiflupyr | Picoxystrobin | Mandestrobin |
| 597. | Benzovindiflupyr | Pyraclostrobin | Mandestrobin |
| 598. | Benzovindiflupyr | Trifloxystrobin | Mandestrobin |
| 599. | Benzovindiflupyr | Fluoxastrobin | Mandestrobin |
| 600. | Benzovindiflupyr | Kresoxim-methyl | Mandestrobin |
| 601. | Benzovindiflupyr | Azoxystrobin | Fluoxastrobin |
| 602. | Benzovindiflupyr | Picoxystrobin | Fluoxastrobin |
| 603. | Benzovindiflupyr | Pyraclostrobin | Fluoxastrobin |
| 604. | Benzovindiflupyr | Trifloxystrobin | Fluoxastrobin |
| 605. | Benzovindiflupyr | Mandestrobin | Fluoxastrobin |
| 606. | Benzovindiflupyr | Kresoxim-methyl | Fluoxastrobin |
| 607. | Benzovindiflupyr | Azoxystrobin | Trifloxystrobin |
| 608. | Benzovindiflupyr | Picoxystrobin | Trifloxystrobin |
| 609. | Benzovindiflupyr | Pyraclostrobin | Trifloxystrobin |
| 610. | Benzovindiflupyr | Fluoxastrobin | Trifloxystrobin |
| 611. | Benzovindiflupyr | Mandestrobin | Trifloxystrobin |
| 612. | Benzovindiflupyr | Kresoxim-methyl | Trifloxystrobin |
| 613. | Benzovindiflupyr | Azoxystrobin | Pyraclostrobin |
| 614. | Benzovindiflupyr | Picoxystrobin | Pyraclostrobin |
| 615. | Benzovindiflupyr | Trifloxystrobin | Pyraclostrobin |
| 616. | Benzovindiflupyr | Fluoxastrobin | Pyraclostrobin |
| 617. | Benzovindiflupyr | Mandestrobin | Pyraclostrobin |
| 618. | Benzovindiflupyr | Kresoxim-methyl | Pyraclostrobin |
| 619. | Benzovindiflupyr | Azoxystrobin | Picoxystrobin |
| 620. | Benzovindiflupyr | Pyraclostrobin | Picoxystrobin |
| 621. | Benzovindiflupyr | Trifloxystrobin | Picoxystrobin |
| 622. | Benzovindiflupyr | Fluoxastrobin | Picoxystrobin |
| 623. | Benzovindiflupyr | Mandestrobin | Picoxystrobin |
| 624. | Benzovindiflupyr | Kresoxim-methyl | Picoxystrobin |
| 625. | Benzovindiflupyr | Picoxystrobin | Azoxystrobin |
| 626. | Benzovindiflupyr | Pyraclostrobin | Azoxystrobin |
| 627. | Benzovindiflupyr | Trifloxystrobin | Azoxystrobin |
| 628. | Benzovindiflupyr | Fluoxastrobin | Azoxystrobin |
| 629. | Benzovindiflupyr | Mandestrobin | Azoxystrobin |
| 630. | Benzovindiflupyr | Kresoxim-methyl | Azoxystrobin |
| 631. | Bixafen | Azoxystrobin | Kresoxim-methyl |
| 632. | Bixafen | Picoxystrobin | Kresoxim-methyl |
| 633. | Bixafen | Pyraclostrobin | Kresoxim-methyl |
| 634. | Bixafen | Trifloxystrobin | Kresoxim-methyl |
| 635. | Bixafen | Fluoxastrobin | Kresoxim-methyl |
| 636. | Bixafen | Mandestrobin | Kresoxim-methyl |
| 637. | Bixafen | Azoxystrobin | Mandestrobin |
| 638. | Bixafen | Picoxystrobin | Mandestrobin |
| 639. | Bixafen | Pyraclostrobin | Mandestrobin |
| 640. | Bixafen | Trifloxystrobin | Mandestrobin |
| 641. | Bixafen | Fluoxastrobin | Mandestrobin |
| 642. | Bixafen | Kresoxim-methyl | Mandestrobin |
| 643. | Bixafen | Azoxystrobin | Fluoxastrobin |
| 644. | Bixafen | Picoxystrobin | Fluoxastrobin |
| 645. | Bixafen | Pyraclostrobin | Fluoxastrobin |
| 646. | Bixafen | Trifloxystrobin | Fluoxastrobin |
| 647. | Bixafen | Mandestrobin | Fluoxastrobin |
| 648. | Bixafen | Kresoxim-methyl | Fluoxastrobin |
| 649. | Bixafen | Azoxystrobin | Trifloxystrobin |
| 650. | Bixafen | Picoxystrobin | Trifloxystrobin |
| 651. | Bixafen | Pyraclostrobin | Trifloxystrobin |
| 652. | Bixafen | Fluoxastrobin | Trifloxystrobin |
| 653. | Bixafen | Mandestrobin | Trifloxystrobin |
| 654. | Bixafen | Kresoxim-methyl | Trifloxystrobin |
| 655. | Bixafen | Azoxystrobin | Pyraclostrobin |
| 656. | Bixafen | Picoxystrobin | Pyraclostrobin |
| 657. | Bixafen | Trifloxystrobin | Pyraclostrobin |
| 658. | Bixafen | Fluoxastrobin | Pyraclostrobin |
| 659. | Bixafen | Mandestrobin | Pyraclostrobin |
| 660. | Bixafen | Kresoxim-methyl | Pyraclostrobin |
| 661. | Bixafen | Azoxystrobin | Picoxystrobin |
| 662. | Bixafen | Pyraclostrobin | Picoxystrobin |
| 663. | Bixafen | Trifloxystrobin | Picoxystrobin |
| 664. | Bixafen | Fluoxastrobin | Picoxystrobin |
| 665. | Bixafen | Mandestrobin | Picoxystrobin |
| 666. | Bixafen | Kresoxim-methyl | Picoxystrobin |
| 667. | Bixafen | Picoxystrobin | Azoxystrobin |
| 668. | Bixafen | Pyraclostrobin | Azoxystrobin |
| 669. | Bixafen | Trifloxystrobin | Azoxystrobin |
| 670. | Bixafen | Fluoxastrobin | Azoxystrobin |
| 671. | Bixafen | Mandestrobin | Azoxystrobin |
| 672. | Bixafen | Kresoxim-methyl | Azoxystrobin |
| 673. | Fluxapyroxad | Azoxystrobin | Kresoxim-methyl |
| 674. | Fluxapyroxad | Picoxystrobin | Kresoxim-methyl |
| 675. | Fluxapyroxad | Pyraclostrobin | Kresoxim-methyl |
| 676. | Fluxapyroxad | Trifloxystrobin | Kresoxim-methyl |
| 677. | Fluxapyroxad | Fluoxastrobin | Kresoxim-methyl |
| 678. | Fluxapyroxad | Mandestrobin | Kresoxim-methyl |
| 679. | Fluxapyroxad | Azoxystrobin | Mandestrobin |
| 680. | Fluxapyroxad | Picoxystrobin | Mandestrobin |
| 681. | Fluxapyroxad | Pyraclostrobin | Mandestrobin |
| 682. | Fluxapyroxad | Trifloxystrobin | Mandestrobin |
| 683. | Fluxapyroxad | Fluoxastrobin | Mandestrobin |
| 684. | Fluxapyroxad | Kresoxim-methyl | Mandestrobin |
| 685. | Fluxapyroxad | Azoxystrobin | Fluoxastrobin |
| 686. | Fluxapyroxad | Picoxystrobin | Fluoxastrobin |
| 687. | Fluxapyroxad | Pyraclostrobin | Fluoxastrobin |
| 688. | Fluxapyroxad | Trifloxystrobin | Fluoxastrobin |
| 689. | Fluxapyroxad | Mandestrobin | Fluoxastrobin |
| 690. | Fluxapyroxad | Kresoxim-methyl | Fluoxastrobin |
| 691. | Fluxapyroxad | Azoxystrobin | Trifloxystrobin |
| 692. | Fluxapyroxad | Picoxystrobin | Trifloxystrobin |
| 693. | Fluxapyroxad | Pyraclostrobin | Trifloxystrobin |
| 694. | Fluxapyroxad | Fluoxastrobin | Trifloxystrobin |
| 695. | Fluxapyroxad | Mandestrobin | Trifloxystrobin |
| 696. | Fluxapyroxad | Kresoxim-methyl | Trifloxystrobin |
| 697. | Fluxapyroxad | Azoxystrobin | Pyraclostrobin |
| 698. | Fluxapyroxad | Picoxystrobin | Pyraclostrobin |
| 699. | Fluxapyroxad | Trifloxystrobin | Pyraclostrobin |
| 700. | Fluxapyroxad | Fluoxastrobin | Pyraclostrobin |
| 701. | Fluxapyroxad | Mandestrobin | Pyraclostrobin |
| 702. | Fluxapyroxad | Kresoxim-methyl | Pyraclostrobin |
| 703. | Fluxapyroxad | Azoxystrobin | Picoxystrobin |
| 704. | Fluxapyroxad | Pyraclostrobin | Picoxystrobin |
| 705. | Fluxapyroxad | Trifloxystrobin | Picoxystrobin |
| 706. | Fluxapyroxad | Fluoxastrobin | Picoxystrobin |
| 707. | Fluxapyroxad | Mandestrobin | Picoxystrobin |
| 708. | Fluxapyroxad | Kresoxim-methyl | Picoxystrobin |
| 709. | Fluxapyroxad | Picoxystrobin | Azoxystrobin |
| 710. | Fluxapyroxad | Pyraclostrobin | Azoxystrobin |
| 711. | Fluxapyroxad | Trifloxystrobin | Azoxystrobin |
| 712. | Fluxapyroxad | Fluoxastrobin | Azoxystrobin |
| 713. | Fluxapyroxad | Mandestrobin | Azoxystrobin |
| 714. | Fluxapyroxad | Kresoxim-methyl | Azoxystrobin |
| 715. | Furametpyr | Azoxystrobin | Kresoxim-methyl |
| 716. | Furametpyr | Picoxystrobin | Kresoxim-methyl |
| 717. | Furametpyr | Pyraclostrobin | Kresoxim-methyl |
| 718. | Furametpyr | Trifloxystrobin | Kresoxim-methyl |
| 719. | Furametpyr | Fluoxastrobin | Kresoxim-methyl |
| 720. | Furametpyr | Mandestrobin | Kresoxim-methyl |
| 721. | Furametpyr | Azoxystrobin | Mandestrobin |
| 722. | Furametpyr | Picoxystrobin | Mandestrobin |
| 723. | Furametpyr | Pyraclostrobin | Mandestrobin |
| 724. | Furametpyr | Trifloxystrobin | Mandestrobin |
| 725. | Furametpyr | Fluoxastrobin | Mandestrobin |
| 726. | Furametpyr | Kresoxim-methyl | Mandestrobin |
| 727. | Furametpyr | Azoxystrobin | Fluoxastrobin |
| 728. | Furametpyr | Picoxystrobin | Fluoxastrobin |
| 729. | Furametpyr | Pyraclostrobin | Fluoxastrobin |
| 730. | Furametpyr | Trifloxystrobin | Fluoxastrobin |
| 731. | Furametpyr | Mandestrobin | Fluoxastrobin |
| 732. | Furametpyr | Kresoxim-methyl | Fluoxastrobin |
| 733. | Furametpyr | Azoxystrobin | Trifloxystrobin |
| 734. | Furametpyr | Picoxystrobin | Trifloxystrobin |
| 735. | Furametpyr | Pyraclostrobin | Trifloxystrobin |
| 736. | Furametpyr | Fluoxastrobin | Trifloxystrobin |
| 737. | Furametpyr | Mandestrobin | Trifloxystrobin |
| 738. | Furametpyr | Kresoxim-methyl | Trifloxystrobin |
| 739. | Furametpyr | Azoxystrobin | Pyraclostrobin |
| 740. | Furametpyr | Picoxystrobin | Pyraclostrobin |
| 741. | Furametpyr | Trifloxystrobin | Pyraclostrobin |
| 742. | Furametpyr | Fluoxastrobin | Pyraclostrobin |
| 743. | Furametpyr | Mandestrobin | Pyraclostrobin |
| 744. | Furametpyr | Kresoxim-methyl | Pyraclostrobin |
| 745. | Furametpyr | Azoxystrobin | Picoxystrobin |
| 746. | Furametpyr | Pyraclostrobin | Picoxystrobin |
| 747. | Furametpyr | Trifloxystrobin | Picoxystrobin |
| 748. | Furametpyr | Fluoxastrobin | Picoxystrobin |
| 749. | Furametpyr | Mandestrobin | Picoxystrobin |
| 750. | Furametpyr | Kresoxim-methyl | Picoxystrobin |
| 751. | Furametpyr | Picoxystrobin | Azoxystrobin |
| 752. | Furametpyr | Pyraclostrobin | Azoxystrobin |
| 753. | Furametpyr | Trifloxystrobin | Azoxystrobin |
| 754. | Furametpyr | Fluoxastrobin | Azoxystrobin |
| 755. | Furametpyr | Mandestrobin | Azoxystrobin |
| 756. | Furametpyr | Kresoxim-methyl | Azoxystrobin |
| 757. | Inpyrfluxam | Azoxystrobin | Kresoxim-methyl |
| 758. | Inpyrfluxam | Picoxystrobin | Kresoxim-methyl |
| 759. | Inpyrfluxam | Pyraclostrobin | Kresoxim-methyl |
| 760. | Inpyrfluxam | Trifloxystrobin | Kresoxim-methyl |
| 761. | Inpyrfluxam | Fluoxastrobin | Kresoxim-methyl |
| 762. | Inpyrfluxam | Mandestrobin | Kresoxim-methyl |
| 763. | Inpyrfluxam | Azoxystrobin | Mandestrobin |
| 764. | Inpyrfluxam | Picoxystrobin | Mandestrobin |
| 765. | Inpyrfluxam | Pyraclostrobin | Mandestrobin |
| 766. | Inpyrfluxam | Trifloxystrobin | Mandestrobin |
| 767. | Inpyrfluxam | Fluoxastrobin | Mandestrobin |
| 768. | Inpyrfluxam | Kresoxim-methyl | Mandestrobin |
| 769. | Inpyrfluxam | Azoxystrobin | Fluoxastrobin |
| 770. | Inpyrfluxam | Picoxystrobin | Fluoxastrobin |
| 771. | Inpyrfluxam | Pyraclostrobin | Fluoxastrobin |
| 772. | Inpyrfluxam | Trifloxystrobin | Fluoxastrobin |
| 773. | Inpyrfluxam | Mandestrobin | Fluoxastrobin |
| II4. | Inpyrfluxam | Kresoxim-methyl | Fluoxastrobin |
| 775. | Inpyrfluxam | Azoxystrobin | Trifloxystrobin |
| 776. | Inpyrfluxam | Picoxystrobin | Trifloxystrobin |
| 777. | Inpyrfluxam | Pyraclostrobin | Trifloxystrobin |
| 778. | Inpyrfluxam | Fluoxastrobin | Trifloxystrobin |
| 779. | Inpyrfluxam | Mandestrobin | Trifloxystrobin |
| 780. | Inpyrfluxam | Kresoxim-methyl | Trifloxystrobin |
| 781. | Inpyrfluxam | Azoxystrobin | Pyraclostrobin |
| 782. | Inpyrfluxam | Picoxystrobin | Pyraclostrobin |
| 783. | Inpyrfluxam | Trifloxystrobin | Pyraclostrobin |
| 784. | Inpyrfluxam | Fluoxastrobin | Pyraclostrobin |
| 785. | Inpyrfluxam | Mandestrobin | Pyraclostrobin |
| 786. | Inpyrfluxam | Kresoxim-methyl | Pyraclostrobin |
| 787. | Inpyrfluxam | Azoxystrobin | Picoxystrobin |
| 788. | Inpyrfluxam | Pyraclostrobin | Picoxystrobin |
| 789. | Inpyrfluxam | Trifloxystrobin | Picoxystrobin |
| 790. | Inpyrfluxam | Fluoxastrobin | Picoxystrobin |
| 791. | Inpyrfluxam | Mandestrobin | Picoxystrobin |
| 792. | Inpyrfluxam | Kresoxim-methyl | Picoxystrobin |
| 793. | Inpyrfluxam | Picoxystrobin | Azoxystrobin |
| 794. | Inpyrfluxam | Pyraclostrobin | Azoxystrobin |
| 795. | Inpyrfluxam | Trifloxystrobin | Azoxystrobin |
| 796. | Inpyrfluxam | Fluoxastrobin | Azoxystrobin |
| 797. | Inpyrfluxam | Mandestrobin | Azoxystrobin |
| 798. | Inpyrfluxam | Kresoxim-methyl | Azoxystrobin |
| 799. | Penflufen | Azoxystrobin | Kresoxim-methyl |
| 800. | Penflufen | Picoxystrobin | Kresoxim-methyl |
| 801. | Penflufen | Pyraclostrobin | Kresoxim-methyl |
| 802. | Penflufen | Trifloxystrobin | Kresoxim-methyl |
| 803. | Penflufen | Fluoxastrobin | Kresoxim-methyl |
| 804. | Penflufen | Mandestrobin | Kresoxim-methyl |
| 805. | Penflufen | Azoxystrobin | Mandestrobin |
| 806. | Penflufen | Picoxystrobin | Mandestrobin |
| 807. | Penflufen | Pyraclostrobin | Mandestrobin |
| 808. | Penflufen | Trifloxystrobin | Mandestrobin |
| 809. | Penflufen | Fluoxastrobin | Mandestrobin |
| 810. | Penflufen | Kresoxim-methyl | Mandestrobin |
| 811. | Penflufen | Azoxystrobin | Fluoxastrobin |
| 812. | Penflufen | Picoxystrobin | Fluoxastrobin |
| 813. | Penflufen | Pyraclostrobin | Fluoxastrobin |
| 814. | Penflufen | Trifloxystrobin | Fluoxastrobin |
| 815. | Penflufen | Mandestrobin | Fluoxastrobin |
| 816. | Penflufen | Kresoxim-methyl | Fluoxastrobin |
| 817. | Penflufen | Azoxystrobin | Trifloxystrobin |
| 818. | Penflufen | Picoxystrobin | Trifloxystrobin |
| 819. | Penflufen | Pyraclostrobin | Trifloxystrobin |
| 820. | Penflufen | Fluoxastrobin | Trifloxystrobin |
| 821. | Penflufen | Mandestrobin | Trifloxystrobin |
| 822. | Penflufen | Kresoxim-methyl | Trifloxystrobin |
| 823. | Penflufen | Azoxystrobin | Pyraclostrobin |
| 824. | Penflufen | Picoxystrobin | Pyraclostrobin |
| 825. | Penflufen | Trifloxystrobin | Pyraclostrobin |
| 826. | Penflufen | Fluoxastrobin | Pyraclostrobin |
| 827. | Penflufen | Mandestrobin | Pyraclostrobin |
| 828. | Penflufen | Kresoxim-methyl | Pyraclostrobin |
| 829. | Penflufen | Azoxystrobin | Picoxystrobin |
| 830. | Penflufen | Pyraclostrobin | Picoxystrobin |
| 831. | Penflufen | Trifloxystrobin | Picoxystrobin |
| 832. | Penflufen | Fluoxastrobin | Picoxystrobin |
| 833. | Penflufen | Mandestrobin | Picoxystrobin |
| 834. | Penflufen | Kresoxim-methyl | Picoxystrobin |
| 835. | Penflufen | Picoxystrobin | Azoxystrobin |
| 836. | Penflufen | Pyraclostrobin | Azoxystrobin |
| 837. | Penflufen | Trifloxystrobin | Azoxystrobin |
| 838. | Penflufen | Fluoxastrobin | Azoxystrobin |
| 839. | Penflufen | Mandestrobin | Azoxystrobin |
| 840. | Penflufen | Kresoxim-methyl | Azoxystrobin |
| 841. | Penthiopyrad | Azoxystrobin | Kresoxim-methyl |
| 842. | Penthiopyrad | Picoxystrobin | Kresoxim-methyl |
| 843. | Penthiopyrad | Pyraclostrobin | Kresoxim-methyl |
| 844. | Penthiopyrad | Trifloxystrobin | Kresoxim-methyl |
| 845. | Penthiopyrad | Fluoxastrobin | Kresoxim-methyl |
| 846. | Penthiopyrad | Mandestrobin | Kresoxim-methyl |
| 847. | Penthiopyrad | Azoxystrobin | Mandestrobin |
| 848. | Penthiopyrad | Picoxystrobin | Mandestrobin |
| 849. | Penthiopyrad | Pyraclostrobin | Mandestrobin |
| 850. | Penthiopyrad | Trifloxystrobin | Mandestrobin |
| 851. | Penthiopyrad | Fluoxastrobin | Mandestrobin |
| 852. | Penthiopyrad | Kresoxim-methyl | Mandestrobin |
| 853. | Penthiopyrad | Azoxystrobin | Fluoxastrobin |
| 854. | Penthiopyrad | Picoxystrobin | Fluoxastrobin |
| 855. | Penthiopyrad | Pyraclostrobin | Fluoxastrobin |
| 856. | Penthiopyrad | Trifloxystrobin | Fluoxastrobin |
| 857. | Penthiopyrad | Mandestrobin | Fluoxastrobin |
| 858. | Penthiopyrad | Kresoxim-methyl | Fluoxastrobin |
| 859. | Penthiopyrad | Azoxystrobin | Trifloxystrobin |
| 860. | Penthiopyrad | Picoxystrobin | Trifloxystrobin |
| 861. | Penthiopyrad | Pyraclostrobin | Trifloxystrobin |
| 862. | Penthiopyrad | Fluoxastrobin | Trifloxystrobin |
| 863. | Penthiopyrad | Mandestrobin | Trifloxystrobin |
| 864. | Penthiopyrad | Kresoxim-methyl | Trifloxystrobin |
| 865. | Penthiopyrad | Azoxystrobin | Pyraclostrobin |
| 866. | Penthiopyrad | Picoxystrobin | Pyraclostrobin |
| 867. | Penthiopyrad | Trifloxystrobin | Pyraclostrobin |
| 868. | Penthiopyrad | Fluoxastrobin | Pyraclostrobin |
| 869. | Penthiopyrad | Mandestrobin | Pyraclostrobin |
| 870. | Penthiopyrad | Kresoxim-methyl | Pyraclostrobin |
| 871. | Penthiopyrad | Azoxystrobin | Picoxystrobin |
| 872. | Penthiopyrad | Pyraclostrobin | Picoxystrobin |
| 873. | Penthiopyrad | Trifloxystrobin | Picoxystrobin |
| 874. | Penthiopyrad | Fluoxastrobin | Picoxystrobin |
| 875. | Penthiopyrad | Mandestrobin | Picoxystrobin |
| 876. | Penthiopyrad | Kresoxim-methyl | Picoxystrobin |
| 877. | Penthiopyrad | Picoxystrobin | Azoxystrobin |
| 878. | Penthiopyrad | Pyraclostrobin | Azoxystrobin |
| 879. | Penthiopyrad | Trifloxystrobin | Azoxystrobin |
| 880. | Penthiopyrad | Fluoxastrobin | Azoxystrobin |
| 881. | Penthiopyrad | Mandestrobin | Azoxystrobin |
| 882. | Penthiopyrad | Kresoxim-methyl | Azoxystrobin |
| 883. | Sedaxane | Azoxystrobin | Kresoxim-methyl |
| 884. | Sedaxane | Picoxystrobin | Kresoxim-methyl |
| 885. | Sedaxane | Pyraclostrobin | Kresoxim-methyl |
| 886. | Sedaxane | Trifloxystrobin | Kresoxim-methyl |
| 887. | Sedaxane | Fluoxastrobin | Kresoxim-methyl |
| 888. | Sedaxane | Mandestrobin | Kresoxim-methyl |
| 889. | Sedaxane | Azoxystrobin | Mandestrobin |
| 890. | Sedaxane | Picoxystrobin | Mandestrobin |
| 891. | Sedaxane | Pyraclostrobin | Mandestrobin |
| 892. | Sedaxane | Trifloxystrobin | Mandestrobin |
| 893. | Sedaxane | Fluoxastrobin | Mandestrobin |
| 894. | Sedaxane | Kresoxim-methyl | Mandestrobin |
| 895. | Sedaxane | Azoxystrobin | Fluoxastrobin |
| 896. | Sedaxane | Picoxystrobin | Fluoxastrobin |
| 897. | Sedaxane | Pyraclostrobin | Fluoxastrobin |
| 898. | Sedaxane | Trifloxystrobin | Fluoxastrobin |
| 899. | Sedaxane | Mandestrobin | Fluoxastrobin |
| 900. | Sedaxane | Kresoxim-methyl | Fluoxastrobin |
| 901. | Sedaxane | Azoxystrobin | Trifloxystrobin |
| 902. | Sedaxane | Picoxystrobin | Trifloxystrobin |
| 903. | Sedaxane | Pyraclostrobin | Trifloxystrobin |
| 904. | Sedaxane | Fluoxastrobin | Trifloxystrobin |
| 905. | Sedaxane | Mandestrobin | Trifloxystrobin |
| 906. | Sedaxane | Kresoxim-methyl | Trifloxystrobin |
| 907. | Sedaxane | Azoxystrobin | Pyraclostrobin |
| 908. | Sedaxane | Picoxystrobin | Pyraclostrobin |
| 909. | Sedaxane | Trifloxystrobin | Pyraclostrobin |
| 910. | Sedaxane | Fluoxastrobin | Pyraclostrobin |
| 911. | Sedaxane | Mandestrobin | Pyraclostrobin |
| 912. | Sedaxane | Kresoxim-methyl | Pyraclostrobin |
| 913. | Sedaxane | Azoxystrobin | Picoxystrobin |
| 914. | Sedaxane | Pyraclostrobin | Picoxystrobin |
| 915. | Sedaxane | Trifloxystrobin | Picoxystrobin |
| 916. | Sedaxane | Fluoxastrobin | Picoxystrobin |
| 917. | Sedaxane | Mandestrobin | Picoxystrobin |
| 918. | Sedaxane | Kresoxim-methyl | Picoxystrobin |
| 919. | Sedaxane | Picoxystrobin | Azoxystrobin |
| 920. | Sedaxane | Pyraclostrobin | Azoxystrobin |
| 921. | Sedaxane | Trifloxystrobin | Azoxystrobin |
| 922. | Sedaxane | Fluoxastrobin | Azoxystrobin |
| 923. | Sedaxane | Mandestrobin | Azoxystrobin |
| 924. | Sedaxane | Kresoxim-methyl | Azoxystrobin |
| 925. | Isopyrazam, | Cyproconazole | Azoxystrobin |
| 926. | Isopyrazam, | Hexaconazole | Azoxystrobin |
| 927. | Isopyrazam, | Tebuconazole | Azoxystrobin |
| 928. | Isopyrazam, | Tetraconazole | Azoxystrobin |
| 929. | Isopyrazam, | Prothioconazole | Azoxystrobin |
| 930. | Isopyrazam, | Epoxiconazole | Azoxystrobin |
| 931. | Isopyrazam, | Difenconazole | Azoxystrobin |
| 932. | Isopyrazam, | Cyproconazole | Picoxystrobin |
| 933. | Isopyrazam, | Hexaconazole | Picoxystrobin |
| 934. | Isopyrazam, | Tebuconazole | Picoxystrobin |
| 935. | Isopyrazam, | Tetraconazole | Picoxystrobin |
| 936. | Isopyrazam, | Prothioconazole | Picoxystrobin |
| 937. | Isopyrazam, | Epoxiconazole | Picoxystrobin |
| 938. | Isopyrazam, | Difenconazole | Picoxystrobin |
| 939. | Isopyrazam, | Cyproconazole | Pyraclostrobin |
| 940. | Isopyrazam, | Hexaconazole | Pyraclostrobin |
| 941. | Isopyrazam, | Tebuconazole | Pyraclostrobin |
| 942. | Isopyrazam, | Tetraconazole | Pyraclostrobin |
| 943. | Isopyrazam, | Prothioconazole | Pyraclostrobin |
| 944. | Isopyrazam, | Epoxiconazole | Pyraclostrobin |
| 945. | Isopyrazam, | Difenconazole | Pyraclostrobin |
| 946. | Isopyrazam, | Cyproconazole | Trifloxystrobin |
| 947. | Isopyrazam, | Hexaconazole | Trifloxystrobin |
| 948. | Isopyrazam, | Tebuconazole | Trifloxystrobin |
| 949. | Isopyrazam, | Tetraconazole | Trifloxystrobin |
| 950. | Isopyrazam, | Prothioconazole | Trifloxystrobin |
| 951. | Isopyrazam, | Epoxiconazole | Trifloxystrobin |
| 952. | Isopyrazam, | Difenconazole | Trifloxystrobin |
| 953. | Isopyrazam, | Cyproconazole | Fluoxastrobin |
| 954. | Isopyrazam, | Hexaconazole | Fluoxastrobin |
| 955. | Isopyrazam, | Tebuconazole | Fluoxastrobin |
| 956. | Isopyrazam, | Tetraconazole | Fluoxastrobin |
| 957. | Isopyrazam, | Prothioconazole | Fluoxastrobin |
| 958. | Isopyrazam, | Epoxiconazole | Fluoxastrobin |
| 959. | Isopyrazam, | Difenconazole | Fluoxastrobin |
| 960. | Isopyrazam, | Cyproconazole | Mandestrobin |
| 961. | Isopyrazam, | Hexaconazole | Mandestrobin |
| 962. | Isopyrazam, | Tebuconazole | Mandestrobin |
| 963. | Isopyrazam, | Tetraconazole | Mandestrobin |
| 964. | Isopyrazam, | Prothioconazole | Mandestrobin |
| 965. | Isopyrazam, | Epoxiconazole | Mandestrobin |
| 966. | Isopyrazam, | Difenconazole | Mandestrobin |
| 967. | Isopyrazam, | Cyproconazole | Kresoxim-methyl |
| 968. | Isopyrazam, | Hexaconazole | Kresoxim-methyl |
| 969. | Isopyrazam, | Tebuconazole | Kresoxim-methyl |
| 970. | Isopyrazam, | Tetraconazole | Kresoxim-methyl |
| 971. | Isopyrazam, | Prothioconazole | Kresoxim-methyl |
| 972. | Isopyrazam, | Epoxiconazole | Kresoxim-methyl |
| 973. | Isopyrazam, | Difenconazole | Kresoxim-methyl |
| 974. | Fluindapyr | Cyproconazole | Azoxystrobin |
| 975. | Fluindapyr | Hexaconazole | Azoxystrobin |
| 976. | Fluindapyr | Tebuconazole | Azoxystrobin |
| 977. | Fluindapyr | Tetraconazole | Azoxystrobin |
| 978. | Fluindapyr | Prothioconazole | Azoxystrobin |
| 979. | Fluindapyr | Epoxiconazole | Azoxystrobin |
| 980. | Fluindapyr | Difenconazole | Azoxystrobin |
| 981. | Fluindapyr | Cyproconazole | Picoxystrobin |
| 982. | Fluindapyr | Hexaconazole | Picoxystrobin |
| 983. | Fluindapyr | Tebuconazole | Picoxystrobin |
| 984. | Fluindapyr | Tetraconazole | Picoxystrobin |
| 985. | Fluindapyr | Prothioconazole | Picoxystrobin |
| 986. | Fluindapyr | Epoxiconazole | Picoxystrobin |
| 987. | Fluindapyr | Difenconazole | Picoxystrobin |
| 988. | Fluindapyr | Cyproconazole | Pyraclostrobin |
| 989. | Fluindapyr | Hexaconazole | Pyraclostrobin |
| 990. | Fluindapyr | Tebuconazole | Pyraclostrobin |
| 991. | Fluindapyr | Tetraconazole | Pyraclostrobin |
| 992. | Fluindapyr | Prothioconazole | Pyraclostrobin |
| 993. | Fluindapyr | Epoxiconazole | Pyraclostrobin |
| 994. | Fluindapyr | Difenconazole | Pyraclostrobin |
| 995. | Fluindapyr | Cyproconazole | Trifloxystrobin |
| 996. | Fluindapyr | Hexaconazole | Trifloxystrobin |
| 997. | Fluindapyr | Tebuconazole | Trifloxystrobin |
| 998. | Fluindapyr | Tetraconazole | Trifloxystrobin |
| 999. | Fluindapyr | Prothioconazole | Trifloxystrobin |
| 1000. | Fluindapyr | Epoxiconazole | Trifloxystrobin |
| 1001. | Fluindapyr | Difenconazole | Trifloxystrobin |
| 1002. | Fluindapyr | Cyproconazole | Fluoxastrobin |
| 1003. | Fluindapyr | Hexaconazole | Fluoxastrobin |
| 1004. | Fluindapyr | Tebuconazole | Fluoxastrobin |
| 1005. | Fluindapyr | Tetraconazole | Fluoxastrobin |
| 1006. | Fluindapyr | Prothioconazole | Fluoxastrobin |
| 1007. | Fluindapyr | Epoxiconazole | Fluoxastrobin |
| 1008. | Fluindapyr | Difenconazole | Fluoxastrobin |
| 1009. | Fluindapyr | Cyproconazole | Mandestrobin |
| 1010. | Fluindapyr | Hexaconazole | Mandestrobin |
| 1011. | Fluindapyr | Tebuconazole | Mandestrobin |
| 1012. | Fluindapyr | Tetraconazole | Mandestrobin |
| 1013. | Fluindapyr | Prothioconazole | Mandestrobin |
| 1014. | Fluindapyr | Epoxiconazole | Mandestrobin |
| 1015. | Fluindapyr | Difenconazole | Mandestrobin |
| 1016. | Fluindapyr | Cyproconazole | Kresoxim-methyl |
| 1017. | Fluindapyr | Hexaconazole | Kresoxim-methyl |
| 1018. | Fluindapyr | Tebuconazole | Kresoxim-methyl |
| 1019. | Fluindapyr | Tetraconazole | Kresoxim-methyl |
| 1020. | Fluindapyr | Prothioconazole | Kresoxim-methyl |
| 1021. | Fluindapyr | Epoxiconazole | Kresoxim-methyl |
| 1022. | Fluindapyr | Difenconazole | Kresoxim-methyl |
| 1023. | Boscalid | Cyproconazole | Azoxystrobin |
| 1024. | Boscalid | Hexaconazole | Azoxystrobin |
| 1025. | Boscalid | Tebuconazole | Azoxystrobin |
| 1026. | Boscalid | Tetraconazole | Azoxystrobin |
| 1027. | Boscalid | Prothioconazole | Azoxystrobin |
| 1028. | Boscalid | Epoxiconazole | Azoxystrobin |
| 1029. | Boscalid | Difenconazole | Azoxystrobin |
| 1030. | Boscalid | Cyproconazole | Picoxystrobin |
| 1031. | Boscalid | Hexaconazole | Picoxystrobin |
| 1032. | Boscalid | Tebuconazole | Picoxystrobin |
| 1033. | Boscalid | Tetraconazole | Picoxystrobin |
| 1034. | Boscalid | Prothioconazole | Picoxystrobin |
| 1035. | Boscalid | Epoxiconazole | Picoxystrobin |
| 1036. | Boscalid | Difenconazole | Picoxystrobin |
| 1037. | Boscalid | Cyproconazole | Pyraclostrobin |
| 1038. | Boscalid | Hexaconazole | Pyraclostrobin |
| 1039. | Boscalid | Tebuconazole | Pyraclostrobin |
| 1040. | Boscalid | Tetraconazole | Pyraclostrobin |
| 1041. | Boscalid | Prothioconazole | Pyraclostrobin |
| 1042. | Boscalid | Epoxiconazole | Pyraclostrobin |
| 1043. | Boscalid | Difenconazole | Pyraclostrobin |
| 1044. | Boscalid | Cyproconazole | Trifloxystrobin |
| 1045. | Boscalid | Hexaconazole | Trifloxystrobin |
| 1046. | Boscalid | Tebuconazole | Trifloxystrobin |
| 1047. | Boscalid | Tetraconazole | Trifloxystrobin |
| 1048. | Boscalid | Prothioconazole | Trifloxystrobin |
| 1049. | Boscalid | Epoxiconazole | Trifloxystrobin |
| 1050. | Boscalid | Difenconazole | Trifloxystrobin |
| 1051. | Boscalid | Cyproconazole | Fluoxastrobin |
| 1052. | Boscalid | Hexaconazole | Fluoxastrobin |
| 1053. | Boscalid | Tebuconazole | Fluoxastrobin |
| 1054. | Boscalid | Tetraconazole | Fluoxastrobin |
| 1055. | Boscalid | Prothioconazole | Fluoxastrobin |
| 1056. | Boscalid | Epoxiconazole | Fluoxastrobin |
| 1057. | Boscalid | Difenconazole | Fluoxastrobin |
| 1058. | Boscalid | Cyproconazole | Mandestrobin |
| 1059. | Boscalid | Hexaconazole | Mandestrobin |
| 1060. | Boscalid | Tebuconazole | Mandestrobin |
| 1061. | Boscalid | Tetraconazole | Mandestrobin |
| 1062. | Boscalid | Prothioconazole | Mandestrobin |
| 1063. | Boscalid | Epoxiconazole | Mandestrobin |
| 1064. | Boscalid | Difenconazole | Mandestrobin |
| 1065. | Boscalid | Cyproconazole | Kresoxim-methyl |
| 1066. | Boscalid | Hexaconazole | Kresoxim-methyl |
| 1067. | Boscalid | Tebuconazole | Kresoxim-methyl |
| 1068. | Boscalid | Tetraconazole | Kresoxim-methyl |
| 1069. | Boscalid | Prothioconazole | Kresoxim-methyl |
| 1070. | Boscalid | Epoxiconazole | Kresoxim-methyl |
| 1071. | Boscalid | Difenconazole | Kresoxim-methyl |
| 1072. | Benzovindiflupyr | Cyproconazole | Azoxystrobin |
| 1073. | Benzovindiflupyr | Hexaconazole | Azoxystrobin |
| 1074. | Benzovindiflupyr | Tebuconazole | Azoxystrobin |
| 1075. | Benzovindiflupyr | Tetraconazole | Azoxystrobin |
| 1076. | Benzovindiflupyr | Prothioconazole | Azoxystrobin |
| 1077. | Benzovindiflupyr | Epoxiconazole | Azoxystrobin |
| 1078. | Benzovindiflupyr | Difenconazole | Azoxystrobin |
| 1079. | Benzovindiflupyr | Cyproconazole | Picoxystrobin |
| 1080. | Benzovindiflupyr | Hexaconazole | Picoxystrobin |
| 1081. | Benzovindiflupyr | Tebuconazole | Picoxystrobin |
| 1082. | Benzovindiflupyr | Tetraconazole | Picoxystrobin |
| 1083. | Benzovindiflupyr | Prothioconazole | Picoxystrobin |
| 1084. | Benzovindiflupyr | Epoxiconazole | Picoxystrobin |
| 1085. | Benzovindiflupyr | Difenconazole | Picoxystrobin |
| 1086. | Benzovindiflupyr | Cyproconazole | Pyraclostrobin |
| 1087. | Benzovindiflupyr | Hexaconazole | Pyraclostrobin |
| 1088. | Benzovindiflupyr | Tebuconazole | Pyraclostrobin |
| 1089. | Benzovindiflupyr | Tetraconazole | Pyraclostrobin |
| 1090. | Benzovindiflupyr | Prothioconazole | Pyraclostrobin |
| 1091. | Benzovindiflupyr | Epoxiconazole | Pyraclostrobin |
| 1092. | Benzovindiflupyr | Difenconazole | Pyraclostrobin |
| 1093. | Benzovindiflupyr | Cyproconazole | Trifloxystrobin |
| 1094. | Benzovindiflupyr | Hexaconazole | Trifloxystrobin |
| 1095. | Benzovindiflupyr | Tebuconazole | Trifloxystrobin |
| 1096. | Benzovindiflupyr | Tetraconazole | Trifloxystrobin |
| 1097. | Benzovindiflupyr | Prothioconazole | Trifloxystrobin |
| 1098. | Benzovindiflupyr | Epoxiconazole | Trifloxystrobin |
| 1099. | Benzovindiflupyr | Difenconazole | Trifloxystrobin |
| 1100. | Benzovindiflupyr | Cyproconazole | Fluoxastrobin |
| 1101. | Benzovindiflupyr | Hexaconazole | Fluoxastrobin |
| 1102. | Benzovindiflupyr | Tebuconazole | Fluoxastrobin |
| 1103. | Benzovindiflupyr | Tetraconazole | Fluoxastrobin |
| 1104. | Benzovindiflupyr | Prothioconazole | Fluoxastrobin |
| 1105. | Benzovindiflupyr | Epoxiconazole | Fluoxastrobin |
| 1106. | Benzovindiflupyr | Difenconazole | Fluoxastrobin |
| 1107. | Benzovindiflupyr | Cyproconazole | Mandestrobin |
| 1108. | Benzovindiflupyr | Hexaconazole | Mandestrobin |
| 1109. | Benzovindiflupyr | Tebuconazole | Mandestrobin |
| 1110. | Benzovindiflupyr | Tetraconazole | Mandestrobin |
| 1111. | Benzovindiflupyr | Prothioconazole | Mandestrobin |
| 1112. | Benzovindiflupyr | Epoxiconazole | Mandestrobin |
| 1113. | Benzovindiflupyr | Difenconazole | Mandestrobin |
| 1114. | Benzovindiflupyr | Cyproconazole | Kresoxim-methyl |
| 1115. | Benzovindiflupyr | Hexaconazole | Kresoxim-methyl |
| 1116. | Benzovindiflupyr | Tebuconazole | Kresoxim-methyl |
| 1117. | Benzovindiflupyr | Tetraconazole | Kresoxim-methyl |
| 1118. | Benzovindiflupyr | Prothioconazole | Kresoxim-methyl |
| 1119. | Benzovindiflupyr | Epoxiconazole | Kresoxim-methyl |
| 1120. | Benzovindiflupyr | Difenconazole | Kresoxim-methyl |
| 1121. | Bixafen | Cyproconazole | Azoxystrobin |
| 1122. | Bixafen | Hexaconazole | Azoxystrobin |
| 1123. | Bixafen | Tebuconazole | Azoxystrobin |
| 1124. | Bixafen | Tetraconazole | Azoxystrobin |
| 1125. | Bixafen | Prothioconazole | Azoxystrobin |
| 1126. | Bixafen | Epoxiconazole | Azoxystrobin |
| 1127. | Bixafen | Difenconazole | Azoxystrobin |
| 1128. | Bixafen | Cyproconazole | Picoxystrobin |
| 1129. | Bixafen | Hexaconazole | Picoxystrobin |
| 1130. | Bixafen | Tebuconazole | Picoxystrobin |
| 1131. | Bixafen | Tetraconazole | Picoxystrobin |
| 1132. | Bixafen | Prothioconazole | Picoxystrobin |
| 1133. | Bixafen | Epoxiconazole | Picoxystrobin |
| 1134. | Bixafen | Difenconazole | Picoxystrobin |
| 1135. | Bixafen | Cyproconazole | Pyraclostrobin |
| 1136. | Bixafen | Hexaconazole | Pyraclostrobin |
| 1137. | Bixafen | Tebuconazole | Pyraclostrobin |
| 1138. | Bixafen | Tetraconazole | Pyraclostrobin |
| 1139. | Bixafen | Prothioconazole | Pyraclostrobin |
| 1140. | Bixafen | Epoxiconazole | Pyraclostrobin |
| 1141. | Bixafen | Difenconazole | Pyraclostrobin |
| 1142. | Bixafen | Cyproconazole | Trifloxystrobin |
| 1143. | Bixafen | Hexaconazole | Trifloxystrobin |
| 1144. | Bixafen | Tebuconazole | Trifloxystrobin |
| 1145. | Bixafen | Tetraconazole | Trifloxystrobin |
| 1146. | Bixafen | Prothioconazole | Trifloxystrobin |
| 1147. | Bixafen | Epoxiconazole | Trifloxystrobin |
| 1148. | Bixafen | Difenconazole | Trifloxystrobin |
| 1149. | Bixafen | Cyproconazole | Fluoxastrobin |
| 1150. | Bixafen | Hexaconazole | Fluoxastrobin |
| 1151. | Bixafen | Tebuconazole | Fluoxastrobin |
| 1152. | Bixafen | Tetraconazole | Fluoxastrobin |
| 1153. | Bixafen | Prothioconazole | Fluoxastrobin |
| 1154. | Bixafen | Epoxiconazole | Fluoxastrobin |
| 1155. | Bixafen | Difenconazole | Fluoxastrobin |
| 1156. | Bixafen | Cyproconazole | Mandestrobin |
| 1157. | Bixafen | Hexaconazole | Mandestrobin |
| 1158. | Bixafen | Tebuconazole | Mandestrobin |
| 1159. | Bixafen | Tetraconazole | Mandestrobin |
| 1160. | Bixafen | Prothioconazole | Mandestrobin |
| 1161. | Bixafen | Epoxiconazole | Mandestrobin |
| 1162. | Bixafen | Difenconazole | Mandestrobin |
| 1163. | Bixafen | Cyproconazole | Kresoxim-methyl |
| 1164. | Bixafen | Hexaconazole | Kresoxim-methyl |
| 1165. | Bixafen | Tebuconazole | Kresoxim-methyl |
| 1166. | Bixafen | Tetraconazole | Kresoxim-methyl |
| 1167. | Bixafen | Prothioconazole | Kresoxim-methyl |
| 1168. | Bixafen | Epoxiconazole | Kresoxim-methyl |
| 1169. | Bixafen | Difenconazole | Kresoxim-methyl |
| 1170. | Fluxapyroxad | Cyproconazole | Azoxystrobin |
| 1171. | Fluxapyroxad | Hexaconazole | Azoxystrobin |
| 1172. | Fluxapyroxad | Tebuconazole | Azoxystrobin |
| 1173. | Fluxapyroxad | Tetraconazole | Azoxystrobin |
| 1174. | Fluxapyroxad | Prothioconazole | Azoxystrobin |
| 1175. | Fluxapyroxad | Epoxiconazole | Azoxystrobin |
| 1176. | Fluxapyroxad | Difenconazole | Azoxystrobin |
| 1177. | Fluxapyroxad | Cyproconazole | Picoxystrobin |
| 1178. | Fluxapyroxad | Hexaconazole | Picoxystrobin |
| 1179. | Fluxapyroxad | Tebuconazole | Picoxystrobin |
| 1180. | Fluxapyroxad | Tetraconazole | Picoxystrobin |
| 1181. | Fluxapyroxad | Prothioconazole | Picoxystrobin |
| 1182. | Fluxapyroxad | Epoxiconazole | Picoxystrobin |
| 1183. | Fluxapyroxad | Difenconazole | Picoxystrobin |
| 1184. | Fluxapyroxad | Cyproconazole | Pyraclostrobin |
| 1185. | Fluxapyroxad | Hexaconazole | Pyraclostrobin |
| 1186. | Fluxapyroxad | Tebuconazole | Pyraclostrobin |
| 1187. | Fluxapyroxad | Tetraconazole | Pyraclostrobin |
| 1188. | Fluxapyroxad | Prothioconazole | Pyraclostrobin |
| 1189. | Fluxapyroxad | Epoxiconazole | Pyraclostrobin |
| 1190. | Fluxapyroxad | Difenconazole | Pyraclostrobin |
| 1191. | Fluxapyroxad | Cyproconazole | Trifloxystrobin |
| 1192. | Fluxapyroxad | Hexaconazole | Trifloxystrobin |
| 1193. | Fluxapyroxad | Tebuconazole | Trifloxystrobin |
| 1194. | Fluxapyroxad | Tetraconazole | Trifloxystrobin |
| 1195. | Fluxapyroxad | Prothioconazole | Trifloxystrobin |
| 1196. | Fluxapyroxad | Epoxiconazole | Trifloxystrobin |
| 1197. | Fluxapyroxad | Difenconazole | Trifloxystrobin |
| 1198. | Fluxapyroxad | Cyproconazole | Fluoxastrobin |
| 1199. | Fluxapyroxad | Hexaconazole | Fluoxastrobin |
| 1200. | Fluxapyroxad | Tebuconazole | Fluoxastrobin |
| 1201. | Fluxapyroxad | Tetraconazole | Fluoxastrobin |
| 1202. | Fluxapyroxad | Prothioconazole | Fluoxastrobin |
| 1203. | Fluxapyroxad | Epoxiconazole | Fluoxastrobin |
| 1204. | Fluxapyroxad | Difenconazole | Fluoxastrobin |
| 1205. | Fluxapyroxad | Cyproconazole | Mandestrobin |
| 1206. | Fluxapyroxad | Hexaconazole | Mandestrobin |
| 1207. | Fluxapyroxad | Tebuconazole | Mandestrobin |
| 1208. | Fluxapyroxad | Tetraconazole | Mandestrobin |
| 1209. | Fluxapyroxad | Prothioconazole | Mandestrobin |
| 1210. | Fluxapyroxad | Epoxiconazole | Mandestrobin |
| 1211. | Fluxapyroxad | Difenconazole | Mandestrobin |
| 1212. | Fluxapyroxad | Cyproconazole | Kresoxim-methyl |
| 1213. | Fluxapyroxad | Hexaconazole | Kresoxim-methyl |
| 1214. | Fluxapyroxad | Tebuconazole | Kresoxim-methyl |
| 1215. | Fluxapyroxad | Tetraconazole | Kresoxim-methyl |
| 1216. | Fluxapyroxad | Prothioconazole | Kresoxim-methyl |
| 1217. | Fluxapyroxad | Epoxiconazole | Kresoxim-methyl |
| 1218. | Fluxapyroxad | Difenconazole | Kresoxim-methyl |
| 1219. | Furametpyr | Cyproconazole | Azoxystrobin |
| 1220. | Furametpyr | Hexaconazole | Azoxystrobin |
| 1221. | Furametpyr | Tebuconazole | Azoxystrobin |
| 1222. | Furametpyr | Tetraconazole | Azoxystrobin |
| 1223. | Furametpyr | Prothioconazole | Azoxystrobin |
| 1224. | Furametpyr | Epoxiconazole | Azoxystrobin |
| 1225. | Furametpyr | Difenconazole | Azoxystrobin |
| 1226. | Furametpyr | Cyproconazole | Picoxystrobin |
| 1227. | Furametpyr | Hexaconazole | Picoxystrobin |
| 1228. | Furametpyr | Tebuconazole | Picoxystrobin |
| 1229. | Furametpyr | Tetraconazole | Picoxystrobin |
| 1230. | Furametpyr | Prothioconazole | Picoxystrobin |
| 1231. | Furametpyr | Epoxiconazole | Picoxystrobin |
| 1232. | Furametpyr | Difenconazole | Picoxystrobin |
| 1233. | Furametpyr | Cyproconazole | Pyraclostrobin |
| 1234. | Furametpyr | Hexaconazole | Pyraclostrobin |
| 1235. | Furametpyr | Tebuconazole | Pyraclostrobin |
| 1236. | Furametpyr | Tetraconazole | Pyraclostrobin |
| 1237. | Furametpyr | Prothioconazole | Pyraclostrobin |
| 1238. | Furametpyr | Epoxiconazole | Pyraclostrobin |
| 1239. | Furametpyr | Difenconazole | Pyraclostrobin |
| 1240. | Furametpyr | Cyproconazole | Trifloxystrobin |
| 1241. | Furametpyr | Hexaconazole | Trifloxystrobin |
| 1242. | Furametpyr | Tebuconazole | Trifloxystrobin |
| 1243. | Furametpyr | Tetraconazole | Trifloxystrobin |
| 1244. | Furametpyr | Prothioconazole | Trifloxystrobin |
| 1245. | Furametpyr | Epoxiconazole | Trifloxystrobin |
| 1246. | Furametpyr | Difenconazole | Trifloxystrobin |
| 1247. | Furametpyr | Cyproconazole | Fluoxastrobin |
| 1248. | Furametpyr | Hexaconazole | Fluoxastrobin |
| 1249. | Furametpyr | Tebuconazole | Fluoxastrobin |
| 1250. | Furametpyr | Tetraconazole | Fluoxastrobin |
| 1251. | Furametpyr | Prothioconazole | Fluoxastrobin |
| 1252. | Furametpyr | Epoxiconazole | Fluoxastrobin |
| 1253. | Furametpyr | Difenconazole | Fluoxastrobin |
| 1254. | Furametpyr | Cyproconazole | Mandestrobin |
| 1255. | Furametpyr | Hexaconazole | Mandestrobin |
| 1256. | Furametpyr | Tebuconazole | Mandestrobin |
| 1257. | Furametpyr | Tetraconazole | Mandestrobin |
| 1258. | Furametpyr | Prothioconazole | Mandestrobin |
| 1259. | Furametpyr | Epoxiconazole | Mandestrobin |
| 1260. | Furametpyr | Difenconazole | Mandestrobin |
| 1261. | Furametpyr | Cyproconazole | Kresoxim-methyl |
| 1262. | Furametpyr | Hexaconazole | Kresoxim-methyl |
| 1263. | Furametpyr | Tebuconazole | Kresoxim-methyl |
| 1264. | Furametpyr | Tetraconazole | Kresoxim-methyl |
| 1265. | Furametpyr | Prothioconazole | Kresoxim-methyl |
| 1266. | Furametpyr | Epoxiconazole | Kresoxim-methyl |
| 1267. | Furametpyr | Difenconazole | Kresoxim-methyl |
| 1268. | Inpyrfluxam | Cyproconazole | Azoxystrobin |
| 1269. | Inpyrfluxam | Hexaconazole | Azoxystrobin |
| 1270. | Inpyrfluxam | Tebuconazole | Azoxystrobin |
| 1271. | Inpyrfluxam | Tetraconazole | Azoxystrobin |
| 1272. | Inpyrfluxam | Prothioconazole | Azoxystrobin |
| 1273. | Inpyrfluxam | Epoxiconazole | Azoxystrobin |
| 1274. | Inpyrfluxam | Difenconazole | Azoxystrobin |
| 1275. | Inpyrfluxam | Cyproconazole | Picoxystrobin |
| 1276. | Inpyrfluxam | Hexaconazole | Picoxystrobin |
| 1277. | Inpyrfluxam | Tebuconazole | Picoxystrobin |
| 1278. | Inpyrfluxam | Tetraconazole | Picoxystrobin |
| 1279. | Inpyrfluxam | Prothioconazole | Picoxystrobin |
| 1280. | Inpyrfluxam | Epoxiconazole | Picoxystrobin |
| 1281. | Inpyrfluxam | Difenconazole | Picoxystrobin |
| 1282. | Inpyrfluxam | Cyproconazole | Pyraclostrobin |
| 1283. | Inpyrfluxam | Hexaconazole | Pyraclostrobin |
| 1284. | Inpyrfluxam | Tebuconazole | Pyraclostrobin |
| 1285. | Inpyrfluxam | Tetraconazole | Pyraclostrobin |
| 1286. | Inpyrfluxam | Prothioconazole | Pyraclostrobin |
| 1287. | Inpyrfluxam | Epoxiconazole | Pyraclostrobin |
| 1288. | Inpyrfluxam | Difenconazole | Pyraclostrobin |
| 1289. | Inpyrfluxam | Cyproconazole | Trifloxystrobin |
| 1290. | Inpyrfluxam | Hexaconazole | Trifloxystrobin |
| 1291. | Inpyrfluxam | Tebuconazole | Trifloxystrobin |
| 1292. | Inpyrfluxam | Tetraconazole | Trifloxystrobin |
| 1293. | Inpyrfluxam | Prothioconazole | Trifloxystrobin |
| 1294. | Inpyrfluxam | Epoxiconazole | Trifloxystrobin |
| 1295. | Inpyrfluxam | Difenconazole | Trifloxystrobin |
| 1296. | Inpyrfluxam | Cyproconazole | Fluoxastrobin |
| 1297. | Inpyrfluxam | Hexaconazole | Fluoxastrobin |
| 1298. | Inpyrfluxam | Tebuconazole | Fluoxastrobin |
| 1299. | Inpyrfluxam | Tetraconazole | Fluoxastrobin |
| 1300. | Inpyrfluxam | Prothioconazole | Fluoxastrobin |
| 1301. | Inpyrfluxam | Epoxiconazole | Fluoxastrobin |
| 1302. | Inpyrfluxam | Difenconazole | Fluoxastrobin |
| 1303. | Inpyrfluxam | Cyproconazole | Mandestrobin |
| 1304. | Inpyrfluxam | Hexaconazole | Mandestrobin |
| 1305. | Inpyrfluxam | Tebuconazole | Mandestrobin |
| 1306. | Inpyrfluxam | Tetraconazole | Mandestrobin |
| 1307. | Inpyrfluxam | Prothioconazole | Mandestrobin |
| 1308. | Inpyrfluxam | Epoxiconazole | Mandestrobin |
| 1309. | Inpyrfluxam | Difenconazole | Mandestrobin |
| 1310. | Inpyrfluxam | Cyproconazole | Kresoxim-methyl |
| 1311. | Inpyrfluxam | Hexaconazole | Kresoxim-methyl |
| 1312. | Inpyrfluxam | Tebuconazole | Kresoxim-methyl |
| 1313. | Inpyrfluxam | Tetraconazole | Kresoxim-methyl |
| 1314. | Inpyrfluxam | Prothioconazole | Kresoxim-methyl |
| 1315. | Inpyrfluxam | Epoxiconazole | Kresoxim-methyl |
| 1316. | Inpyrfluxam | Difenconazole | Kresoxim-methyl |
| 1317. | Penflufen | Cyproconazole | Azoxystrobin |
| 1318. | Penflufen | Hexaconazole | Azoxystrobin |
| 1319. | Penflufen | Tebuconazole | Azoxystrobin |
| 1320. | Penflufen | Tetraconazole | Azoxystrobin |
| 1321. | Penflufen | Prothioconazole | Azoxystrobin |
| 1322. | Penflufen | Epoxiconazole | Azoxystrobin |
| 1323. | Penflufen | Difenconazole | Azoxystrobin |
| 1324. | Penflufen | Cyproconazole | Picoxystrobin |
| 1325. | Penflufen | Hexaconazole | Picoxystrobin |
| 1326. | Penflufen | Tebuconazole | Picoxystrobin |
| 1327. | Penflufen | Tetraconazole | Picoxystrobin |
| 1328. | Penflufen | Prothioconazole | Picoxystrobin |
| 1329. | Penflufen | Epoxiconazole | Picoxystrobin |
| 1330. | Penflufen | Difenconazole | Picoxystrobin |
| 1331. | Penflufen | Cyproconazole | Pyraclostrobin |
| 1332. | Penflufen | Hexaconazole | Pyraclostrobin |
| 1333. | Penflufen | Tebuconazole | Pyraclostrobin |
| 1334. | Penflufen | Tetraconazole | Pyraclostrobin |
| 1335. | Penflufen | Prothioconazole | Pyraclostrobin |
| 1336. | Penflufen | Epoxiconazole | Pyraclostrobin |
| 1337. | Penflufen | Difenconazole | Pyraclostrobin |
| 1338. | Penflufen | Cyproconazole | Trifloxystrobin |
| 1339. | Penflufen | Hexaconazole | Trifloxystrobin |
| 1340. | Penflufen | Tebuconazole | Trifloxystrobin |
| 1341. | Penflufen | Tetraconazole | Trifloxystrobin |
| 1342. | Penflufen | Prothioconazole | Trifloxystrobin |
| 1343. | Penflufen | Epoxiconazole | Trifloxystrobin |
| 1344. | Penflufen | Difenconazole | Trifloxystrobin |
| 1345. | Penflufen | Cyproconazole | Fluoxastrobin |
| 1346. | Penflufen | Hexaconazole | Fluoxastrobin |
| 1347. | Penflufen | Tebuconazole | Fluoxastrobin |
| 1348. | Penflufen | Tetraconazole | Fluoxastrobin |
| 1349. | Penflufen | Prothioconazole | Fluoxastrobin |
| 1350. | Penflufen | Epoxiconazole | Fluoxastrobin |
| 1351. | Penflufen | Difenconazole | Fluoxastrobin |
| 1352. | Penflufen | Cyproconazole | Mandestrobin |
| 1353. | Penflufen | Hexaconazole | Mandestrobin |
| 1354. | Penflufen | Tebuconazole | Mandestrobin |
| 1355. | Penflufen | Tetraconazole | Mandestrobin |
| 1356. | Penflufen | Prothioconazole | Mandestrobin |
| 1357. | Penflufen | Epoxiconazole | Mandestrobin |
| 1358. | Penflufen | Difenconazole | Mandestrobin |
| 1359. | Penflufen | Cyproconazole | Kresoxim-methyl |
| 1360. | Penflufen | Hexaconazole | Kresoxim-methyl |
| 1361. | Penflufen | Tebuconazole | Kresoxim-methyl |
| 1362. | Penflufen | Tetraconazole | Kresoxim-methyl |
| 1363. | Penflufen | Prothioconazole | Kresoxim-methyl |
| 1364. | Penflufen | Epoxiconazole | Kresoxim-methyl |
| 1365. | Penflufen | Difenconazole | Kresoxim-methyl |
| 1366. | Penthiopyrad | Cyproconazole | Azoxystrobin |
| 1367. | Penthiopyrad | Hexaconazole | Azoxystrobin |
| 1368. | Penthiopyrad | Tebuconazole | Azoxystrobin |
| 1369. | Penthiopyrad | Tetraconazole | Azoxystrobin |
| 1370. | Penthiopyrad | Prothioconazole | Azoxystrobin |
| 1371. | Penthiopyrad | Epoxiconazole | Azoxystrobin |
| 1372. | Penthiopyrad | Difenconazole | Azoxystrobin |
| 1373. | Penthiopyrad | Cyproconazole | Picoxystrobin |
| 1374. | Penthiopyrad | Hexaconazole | Picoxystrobin |
| 1375. | Penthiopyrad | Tebuconazole | Picoxystrobin |
| 1376. | Penthiopyrad | Tetraconazole | Picoxystrobin |
| 1377. | Penthiopyrad | Prothioconazole | Picoxystrobin |
| 1378. | Penthiopyrad | Epoxiconazole | Picoxystrobin |
| 1379. | Penthiopyrad | Difenconazole | Picoxystrobin |
| 1380. | Penthiopyrad | Cyproconazole | Pyraclostrobin |
| 1381. | Penthiopyrad | Hexaconazole | Pyraclostrobin |
| 1382. | Penthiopyrad | Tebuconazole | Pyraclostrobin |
| 1383. | Penthiopyrad | Tetraconazole | Pyraclostrobin |
| 1384. | Penthiopyrad | Prothioconazole | Pyraclostrobin |
| 1385. | Penthiopyrad | Epoxiconazole | Pyraclostrobin |
| 1386. | Penthiopyrad | Difenconazole | Pyraclostrobin |
| 1387. | Penthiopyrad | Cyproconazole | Trifloxystrobin |
| 1388. | Penthiopyrad | Hexaconazole | Trifloxystrobin |
| 1389. | Penthiopyrad | Tebuconazole | Trifloxystrobin |
| 1390. | Penthiopyrad | Tetraconazole | Trifloxystrobin |
| 1391. | Penthiopyrad | Prothioconazole | Trifloxystrobin |
| 1392. | Penthiopyrad | Epoxiconazole | Trifloxystrobin |
| 1393. | Penthiopyrad | Difenconazole | Trifloxystrobin |
| 1394. | Penthiopyrad | Cyproconazole | Fluoxastrobin |
| 1395. | Penthiopyrad | Hexaconazole | Fluoxastrobin |
| 1396. | Penthiopyrad | Tebuconazole | Fluoxastrobin |
| 1397. | Penthiopyrad | Tetraconazole | Fluoxastrobin |
| 1398. | Penthiopyrad | Prothioconazole | Fluoxastrobin |
| 1399. | Penthiopyrad | Epoxiconazole | Fluoxastrobin |
| 1400. | Penthiopyrad | Difenconazole | Fluoxastrobin |
| 1401. | Penthiopyrad | Cyproconazole | Mandestrobin |
| 1402. | Penthiopyrad | Hexaconazole | Mandestrobin |
| 1403. | Penthiopyrad | Tebuconazole | Mandestrobin |
| 1404. | Penthiopyrad | Tetraconazole | Mandestrobin |
| 1405. | Penthiopyrad | Prothioconazole | Mandestrobin |
| 1406. | Penthiopyrad | Epoxiconazole | Mandestrobin |
| 1407. | Penthiopyrad | Difenconazole | Mandestrobin |
| 1408. | Penthiopyrad | Cyproconazole | Kresoxim-methyl |
| 1409. | Penthiopyrad | Hexaconazole | Kresoxim-methyl |
| 1410. | Penthiopyrad | Tebuconazole | Kresoxim-methyl |
| 1411. | Penthiopyrad | Tetraconazole | Kresoxim-methyl |
| 1412. | Penthiopyrad | Prothioconazole | Kresoxim-methyl |
| 1413. | Penthiopyrad | Epoxiconazole | Kresoxim-methyl |
| 1414. | Penthiopyrad | Difenconazole | Kresoxim-methyl |
| 1415. | Sedaxane | Cyproconazole | Azoxystrobin |
| 1416. | Sedaxane | Hexaconazole | Azoxystrobin |
| 1417. | Sedaxane | Tebuconazole | Azoxystrobin |
| 1418. | Sedaxane | Tetraconazole | Azoxystrobin |
| 1419. | Sedaxane | Prothioconazole | Azoxystrobin |
| 1420. | Sedaxane | Epoxiconazole | Azoxystrobin |
| 1421. | Sedaxane | Difenconazole | Azoxystrobin |
| 1422. | Sedaxane | Cyproconazole | Picoxystrobin |
| 1423. | Sedaxane | Hexaconazole | Picoxystrobin |
| 1424. | Sedaxane | Tebuconazole | Picoxystrobin |
| 1425. | Sedaxane | Tetraconazole | Picoxystrobin |
| 1426. | Sedaxane | Prothioconazole | Picoxystrobin |
| 1427. | Sedaxane | Epoxiconazole | Picoxystrobin |
| 1428. | Sedaxane | Difenconazole | Picoxystrobin |
| 1429. | Sedaxane | Cyproconazole | Pyraclostrobin |
| 1430. | Sedaxane | Hexaconazole | Pyraclostrobin |
| 1431. | Sedaxane | Tebuconazole | Pyraclostrobin |
| 1432. | Sedaxane | Tetraconazole | Pyraclostrobin |
| 1433. | Sedaxane | Prothioconazole | Pyraclostrobin |
| 1434. | Sedaxane | Epoxiconazole | Pyraclostrobin |
| 1435. | Sedaxane | Difenconazole | Pyraclostrobin |
| 1436. | Sedaxane | Cyproconazole | Trifloxystrobin |
| 1437. | Sedaxane | Hexaconazole | Trifloxystrobin |
| 1438. | Sedaxane | Tebuconazole | Trifloxystrobin |
| 1439. | Sedaxane | Tetraconazole | Trifloxystrobin |
| 1440. | Sedaxane | Prothioconazole | Trifloxystrobin |
| 1441. | Sedaxane | Epoxiconazole | Trifloxystrobin |
| 1442. | Sedaxane | Difenconazole | Trifloxystrobin |
| 1443. | Sedaxane | Cyproconazole | Fluoxastrobin |
| 1444. | Sedaxane | Hexaconazole | Fluoxastrobin |
| 1445. | Sedaxane | Tebuconazole | Fluoxastrobin |
| 1446. | Sedaxane | Tetraconazole | Fluoxastrobin |
| 1447. | Sedaxane | Prothioconazole | Fluoxastrobin |
| 1448. | Sedaxane | Epoxiconazole | Fluoxastrobin |
| 1449. | Sedaxane | Difenconazole | Fluoxastrobin |
| 1450. | Sedaxane | Cyproconazole | Mandestrobin |
| 1451. | Sedaxane | Hexaconazole | Mandestrobin |
| 1452. | Sedaxane | Tebuconazole | Mandestrobin |
| 1453. | Sedaxane | Tetraconazole | Mandestrobin |
| 1454. | Sedaxane | Prothioconazole | Mandestrobin |
| 1455. | Sedaxane | Epoxiconazole | Mandestrobin |
| 1456. | Sedaxane | Difenconazole | Mandestrobin |
| 1457. | Sedaxane | Cyproconazole | Kresoxim-methyl |
| 1458. | Sedaxane | Hexaconazole | Kresoxim-methyl |
| 1459. | Sedaxane | Tebuconazole | Kresoxim-methyl |
| 1460. | Sedaxane | Tetraconazole | Kresoxim-methyl |
| 1461. | Sedaxane | Prothioconazole | Kresoxim-methyl |
| 1462. | Sedaxane | Epoxiconazole | Kresoxim-methyl |
| 1463. | Sedaxane | Difenconazole | Kresoxim-methyl |

The combinations of the present invention may be formulated in the form of a composition.

In an embodiment, the present invention provides a composition comprising a combination as described hereinabove in any one of the aspects or embodiments, and at least one agrochemically acceptable excipient.

In an embodiment, the present invention provides a composition consisting of a combination as described hereinabove in any one of the aspects or embodiments, and at least one agrochemically acceptable excipient.

In an embodiment, the present invention may provide a composition comprising:
a) at least one succinate dehydrogenase inhibitor fungicide;
b) at least two fungicides selected from Demethylation Inhibitor (DMI) fungicides or Quinone outside Inhibitors (QoI) fungicides or a combination of Demethylation Inhibitor (DMI) fungicides and Quinone outside Inhibitors (QoI) fungicides; and
c) at least one agrochemically acceptable excipient.

In an embodiment, the present invention may provide a composition comprising:
(a) at least one succinate dehydrogenase inhibitor fungicide;
(b) at least two fungicides selected from Demethylation Inhibitor (DMI) fungicides or Quinone outside Inhibitors (QoI) fungicides or a combination of Demethylation Inhibitor (DMI) fungicides and Quinone outside Inhibitors (QoI) fungicides;
(c) at least one other agrochemical active; and
(d) at least one agrochemically acceptable excipient.

The agrochemical active may be selected from herbicides, insecticides, miticides, acaricide, fertilizers, plant growth regulators, biocides and the like.

The amount of a composition according to the invention to be applied, will depend on various factors, such as the subject of the treatment, such as, for example plants, soil or seeds; the type of treatment, such as, for example spraying, dusting or seed dressing; the purpose of the treatment, such as, for example prophylactic or therapeutic disease control; in case of disease control the type of fungi to be controlled or the application time. This amount of the combinations of the present invention to be applied can be readily deduced by a skilled agronomist.

Thus in an embodiment, the present invention may provide compositions comprising:
(a) at least one pyrazaole carboxamide selected from benzovindiflupyr, bixafen, fluxapyroxad, Fluindapyr, furametpyr, isopyrazam, penflufen, penthiopyrad, and sedaxane;
(b) at least two fungicides selected from Demethylation Inhibitor (DMI) fungicides or Quinone outside Inhibitors (QoI) fungicides or a combination of Demethylation Inhibitor (DMI) fungicides and Quinone outside Inhibitors (QoI) fungicides; and
   said fungicides being combined in agrochemically acceptable amounts.

In an embodiment, the total amount of succinate dehydrogenase inhibitor in the composition may typically be in the range of 0.1 to 99% by weight, preferably 0.2 to 90% by weight. The total amount of at least two demethylation Inhibitor (DMI) fungicides in the composition may be in the range of 0.1 to 99% by weight.

In an embodiment, the constituent fungicides of the combination of the present invention may be admixed in ratio of (1-80):(1-80):(1-80) of the succinate dehydrogenase inhibitor fungicide and at least two demethylation Inhibitor (DMI) fungicides respectively.

In an embodiment, the constituents of the composition of the present invention may be tank mixed and sprayed at the locus of the infection, or may be alternatively be mixed with surfactants and then sprayed.

In an embodiment, the constituents of the composition of the present invention may be used for foliar application, ground or applications to plant propagation materials.

In an embodiment, the compositions of the present invention may typically be produced by mixing the actives in the composition with an inert carrier, and adding surfactants and other adjuvants and carriers as needed and formulated into solid, or liquid formulations, including but not limited to wettable powders, granules, dusts, Soluble (liquid) concentrates, suspension concentrates, oil in water emulsion, water in oil emulsion, emulsifiable concentrates, capsule suspensions, ZC formulations, oil dispersions or other known formulation types. The composition may also be used for treatment of a plant propagation material such as seeds etc.

Examples of the solid carrier used in formulation include fine powders or granules such as minerals such as kaolin clay, attapulgite clay, bentonite, montmorillonite, acid white clay, pyrophyllite, talc, diatomaceous earth and calcite; natural organic materials such as corn rachis powder and walnut husk powder; synthetic organic materials such as urea; salts such as calcium carbonate and ammonium sulfate; synthetic inorganic materials such as synthetic hydrated silicon oxide; and as a liquid carrier, aromatic hydrocarbons such as xylene, alkylbenzene and methylnaphthalene; alcohols such as 2-propanol, ethyleneglycol, propylene glycol, and ethylene glycol monoethyl ether; ketones such as acetone, cyclohexanone and isophorone; vegetable oil such as soybean oil and cotton seed oil; petroleum aliphatic hydrocarbons, esters, dimethylsulfoxide, acetonitrile and water.

Examples of the surfactant include anionic surfactants such as alkyl sulfate ester salts, alkylaryl sulfonate salts, dialkyl sulfosuccinate salts, polyoxyethylene alkylaryl ether phosphate ester salts, lignosulfonate salts and naphthalene sulfonate formaldehyde polycondensates; and nonionic surfactants such as polyoxyethylene alkyl aryl ethers, polyoxyethylene alkylpolyoxypropylene block copolymers and sorbitan fatty acid esters and cationic surfactants such as alkyltrimethylammonium salts.

Examples of the other formulation auxiliary agents include water-soluble polymers such as polyvinyl alcohol and polyvinylpyrrolidone, polysaccharides such as Arabic gum, alginic acid and the salt thereof, CMC (carboxymethyl-cellulose), Xanthan gum, inorganic materials such as aluminum magnesium silicate and alumina sol, preservatives, coloring agents and stabilization agents such as PAP (acid phosphate isopropyl) and BHT.

The compositions according to the present invention is effective for the following plant diseases:

Disease in rice: Blast (Magnaporthe grisea), Helminthosporium leaf spot (Cochliobolus miyabeanus), sheath blight (Rhizoctonia solani), and bakanae disease (Gibberella fujikuroi).

Diseases in wheat: powdery mildew (Erysiphe graminis), Fusariuin head blight (Fusarium graminearum, F. avenacerum, F. culmorum, Microdochium nivale), rust (Puccinia striiformis, P. graminis, P. recondita), pink snow mold (Micronectriella nivale), Typhula snow blight (Typhula sp.), loose smut (Ustilago tritici), bunt (Tilletia caries), eyespot (Pseudocercosporella herpotrichoides), leaf blotch (Mycosphaerella graminicola), glume blotch (Stagonospora nodorum), septoria, and yellow spot (Pyrenophora tritici-repentis).

Diseases of barley: powdery mildew (Erysiphe graminis), Fusarium head blight (Fusarium graminearum, F. avenacerum, F. culmorum, Microdochium nivale), rust (Puccinia striiformis, P. graminis, P. hordei), loose smut (Ustilago nuda), scald (Rhynchosporium secalis), net blotch (Pyrenophora teres), spot blotch (Cochliobolus sativus), leaf stripe (Pyrenophora graminea), and Rhizoctonia damping-off (Rhizoctonia solani).

Diseases in corn: smut (Ustilago maydis), brown spot (Cochliobolus heterostrophus), copper spot (Gloeocercospora sorghi), southern rust (Puccinia polysora), gray leaf spot (Cercospora zeae-maydis), white spot (Phaeosphaeria mydis and/or Pantoea ananatis) and Rhizoctonia damping-off (Rhizoctonia solani).

Diseases of citrus: melanose (Diaporthe citri), scab (Elsinoe fawcetti), penicillium rot (Penicillium digitatum, P. italicum), and brown rot (Phytophthora parasitica, Phytophthora citrophthora).

Diseases of apple: blossom blight (Monilinia mali), canker (Valsa ceratosperma), powdery mildew (Podosphaera leucotricha), Alternaria leaf spot (Alternaria alternata apple pathotype), scab (Venturia inaequalis), powdery mildew, bitter rot (Colletotrichum acutatum), crown rot (Phytophtora cactorum), blotch (Diplocarpon mali), and ring rot (Botryosphaeria berengeriana).

Diseases of pear: scab (Venturia nashicola, V. pirina), powdery mildew, black spot (Alternaria alternata Japanese pear pathotype), rust (Gymnosporangium haraeanum), and phytophthora fruit rot (Phytophtora cactorum).

Diseases of peach: brown rot (Monilinia fructicola), powdery mildew, scab (Cladosporium carpophilum), and phomopsis rot (Phomopsis sp.).

Diseases of grape: anthracnose (Elsinoe ampelina), ripe rot (Glomerella cingulata), powdery mildew (Uncinula necator), rust (Phakopsora ampelopsidis), black rot (Guignardia bidwellii), botrytis, and downy mildew (Plasmopara viticola).

Diseases of Japanese persimmon: anthracnose (Gloeosporium kaki), and leaf spot (Cercospora kaki, Mycosphaerella nawae).

Diseases of gourd: anthracnose (Colletotrichum lagenarium), powdery mildew (Sphaerotheca fuliginea), gummy stem blight (Mycosphaerella melonis), Fusarium wilt (Fusarium oxysporum), downy mildew (Pseudoperonospora cubensis), Phytophthora rot (Phytophthora sp.), and damping-off (Pythium sp).

Diseases of tomato: early blight (Alternaria solani), leaf mold (Cladosporium fulvum), and late blight (Phytophthora infestans).

Diseases of eggplant: brown spot (Phomopsis vexans), and powdery mildew (Erysiphe cichoracearum) Diseases of cruciferous vegetables: Alternaria leaf spot (Alternaria japonica), white spot (Cercosporella brassicae), clubroot (Plasmodiophora brassicae), and downy mildew (Peronospora parasitica).

Diseases of onion: rust (Puccinia allii), and downy mildew (Peronospora destructor).

Diseases of soybean: purple seed stain (Cercospora kikuchii), sphaceloma scad (Elsinoe glycines), pod and stem blight (Diaporthe phaseolorum var. sojae), septoria brown spot (Septoria glycines), frogeye leaf spot (Cercospora sojina), rust (Phakopsora pachyrhizi, Phakopsora meibomiae), Yellow rust, brown stem rot (Phytophthora sojae), and Rhizoctonia damping-off (Rhizoctonia solani).

Diseases of kidney bean: anthracnose (Colletotrichum lindemthianum). Diseases of peanut: leaf spot (Cercospora personata), brown leaf spot (Cercospora arachidicola) and southern blight (Sclerotium rolfsii).

Diseases of garden pea: powdery mildew (Erysiphe pisi), and root rot (Fusarium solani f. sp. pisi).

Diseases of potato: early blight (Alternaria solani), late blight (Phytophthora infestans), pink rot (Phytophthora erythroseptica), and powdery scab (Spongospora subterranean f sp. subterranea).

Diseases of strawberry: powdery mildew (Sphaerotheca humuli), and anthracnose (Glomerella cingulata).

Diseases of tea: net blister blight (Exobasidium reticulatum), white scab (Elsinoe leucospila), gray blight (Pestalotiopsis sp.), and anthracnose (Colletotrichum theae-sinensis).

Diseases of tobacco: brown spot (Alternaria longipes), powdery mildew (Erysiphe cichoracearum), anthracnose (Colletotrichum tabacum), downy mildew (Peronospora tabacina), and black shank (Phytophthora nicotianae).

Diseases of rapeseed: sclerotinia rot (Sclerotinia sclerotiorum), and Rhizoctonia damping-off (Rhizoctonia solani). Diseases of cotton: Rhizoctonia damping-off (Rhizoctonia solani).

Diseases of sugar beat: Cercospora leaf spot (Cercospora beticola), leaf blight (Thanatephorus cucumeris), Root rot (Thanatephorus cucumeris), and Aphanomyces root rot (Aphanomyces cochlioides).

Diseases of rose: black spot (Diplocarpon rosae), powdery mildew (Sphaerotheca pannosa), and downy mildew (Peronospora sparsa). Diseases of chrysanthemum and asteraceous plants: downy mildew (Bremia lactucae), leaf blight (Septoria chrysanthemi-indici), and white rust (Puccinia horiana).

Diseases of various groups: diseases caused by Pythium spp. (Pythium aphanidermatum, Pythium debarianum, Pythium graminicola, Pythium irregulare, Pythium ultimum), gray mold. (Botrytis cinerea), and Sclerotinia rot (Sclerotinia sclerotiorum).

Disease of Japanese radish: Alternaria leaf spot (Alternaria brassicicola).

Diseases of turfgrass: dollar spot (Sclerotinia homeocarpa), and brown patch and large patch (Rhizoctonia solani).

Disease of banana: Black sigatoka (Mycosphaerella fijiensis), Yellow sigatoka (Mycosphaerella musicola).

Disease of sunflower: downy mildew (Plasmopara halstedii).

Seed diseases or diseases in the early stages of the growth of various plants caused by Aspergillus spp., Penicillium spp., Fusarium spp., Gibberella spp., Tricoderma spp., Thielaviopsis spp., Rhizopus spp., Mucor spp., Corticium spp., Phoma spp., Rhizoctonia spp. and Diplodia spp.

Viral diseases of various plants mediated by Polymixa spp. or Olpidium spp. and so on.

The compositions of the present invention can be used in agricultural lands such as fields, paddy fields, lawns and orchards or in non-agricultural lands. The present invention may be used to control diseases in agricultural lands for cultivating the plants without any phytotoxicity to the plant.

Examples of the crops on which the present compositions may be used include but are not limited to corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

In an aspect, the present invention may provide methods of controlling fungal diseases comprising applying a combination comprising:
a) at least one succinate dehydrogenase inhibitor fungicide; and
b) at least two fungicides selected from Demethylation Inhibitor (DMI) fungicides or Quinone outside Inhibitors (QoI) fungicides or a combination of Demethylation Inhibitor (DMI) fungicides and Quinone outside Inhibitors (QoI) fungicides.

In an embodiment, the succinate dehydrogenase inhibitor fungicide and the at least two demethylation Inhibitor (DMI) fungicides may be selected according to any of the preferred embodiments of the combinations described hereinabove.

The combinations of the present invention may be sold as a pre-mix composition or a kit of parts such that individual actives may be mixed before spraying. Alternatively, the kit of parts may contain succinate dehydrogenase inhibitor fungicide and at least two fungicides selected from Demethylation Inhibitor (DMI) fungicides or Quinone outside Inhibitors (QoI) fungicides or a combination of Demethylation Inhibitor (DMI) fungicides and Quinone outside Inhibitors (QoI) fungicides may be admixed with an adjuvant such that the two components may be tank mixed before spraying.

The composition of the present invention may be applied simultaneously as a tank mix or a formulation or may be applied sequentially. The application may be made to the soil before emergence of the plants, either pre-planting or post-planting. The application may be made as a foliar spray at different timings during crop development, with either one or two applications early or late post-emergence.

The compositions according to the invention can be applied before or after infection of the useful plants or the propagation material thereof by the fungi.

### One or More Advantages of the Present Invention

In an embodiment, the present invention discloses a triple combination of at least three fungicides comprising at least one dehydrogenase inhibitor fungicide, and at least two quinone outside inhibitor fungicides or at least two demethylation inhibitor fungicides, or a combination thereof.

Fungicides most commonly used for fungal infestation management are typically divided into two classes: demethylation inhibitors (DMI) and quinone outside inhibitors (QoI). DMI and QoI fungicides are locally systemic, meaning that they are taken up by the leaves and move within the leaf but not necessarily from leaf to leaf. SeveralDMI and QoIfungicides, including 6 triazoles, 2 strobilurins, 5 triazoles+strobilurins and 1 triazole+benzimidazole have been in use for fungal control. Sensitivity monitoring tests by various groups in the industry revealed that the efficacy of the fungicides has been decreasing significantly over the years.

Research shows a clear trend towards decreasing efficacy of fungicides in controlling soybean rust and other fungal severity or increasing yield in 2013, when compared with 2006 or 2007.

Studies conducted so far by scientists in this field established a gradual decay in the efficacy of strobilurins, or conazoles or their mixtures towards the control of fungi, with their use, gradually over the years.

“Combinations of strobilurins with triazoles improved disease and yield loss control compared with either class alone . . . the reduced performance of triazoles observed 7 years after the introduction of P. pachyrhizi in Brazil, it reached a level at which rust control with straight azoles became unsatisfactory. Since 2007, the use of straight azoles has been decreasing and the use of triazole— strobilurin mixtures was intensified as the major strategy to reduce the risk of resistance.

However, the combination of such triazole and strobilurin did not provide a consistent fungal control, tested from 2006/07 to 2009/10. Further, the studies show a decrease in the efficacy of the combination of triazole and strobilurin after use over a few years.

A review article presenting a meta-analytical synthesis of the results of 71 uniform fungicide trials containing 930 specific fungicide treatments for the control of soybean rust, and yet concluded that combinations of strobilurins with triazoles was the best treatment available in the industry. Later, evidence showed that even the efficacy of this best possible treatment by combinations of strobilurins with triazoles was seen to be decaying with gradual decay over the years.

A network of uniform fungicide trials (UFTs), involved in annually evaluating fungicides since the 2003/04 season provided evidence suggesting a decline in sensitivity within the local fungal populations to multiple fungicides, since efficacy has been relatively low and apparently decreasing in recent years compared to previous reports.

It was reported that in 2005/06 season, average fungal control by DMIs was 90.3%. After only eight seasons, corresponding to 2012/13, DMI control was 52.0%, showing 42% control efficacy reduction. The reduction in fungal sensitivity to the fungicides tebuconazole and cyproconazole, with only 42 and 38% control, respectively, was also established.

In that same season, DMI+QoI mixtures did not show reduced efficiency yet; cyproconazole azoxystrobin had 72% control and pyraclostrobin epoxyconazole, 88% control. At this time, the mean control for the mixtures was 80%. It is likely that the effectiveness was ensured by QoIs, as the control mean for DMI was only 40%. DMI and QoI fungicides act on only one specific site of thousands of biochemical reactions in the fungal cell. Therefore, they are vulnerable to fungal strain selection towards sensitivity reduction or loss. The difficulty in controlling fungi with fungicides is becoming increasingly evident, proving the high fungal adaptability.

As an example, tebuconazole efficiency has been gradually reduced from 90% to 24% in ten seasons. Some actions needed to be taken to make fungal chemical control reach 80-90% efficiency again, as in 2002/03 to 2008/09 growing seasons.

Data obtained from the studies conducted by Embrapa Soybean, showed a marked reduction, with an increase in the reduction every year, in the efficacy of soybean rust control. Yet, during those years almost 80% of the soybean rust control industry was using mixtures of systemic fungicides despite of the reduction in efficacy.

The poor fungicide performances are possibly linked to reports of resistance to DMI and QoI fungicides.

As such, the industry was faced with a problem in the resistance management of fungicidal combinations and was in dire need of a solution to address such problem of reducing efficacy of known fungicides.

Recognizing the problem, i.e., decrease in the efficacy of combinations of various systemic fungicides, different approaches to maintain the efficacy of the systemic fungicides were undertaken.

“After 2007/2008, the decrease in efficacy became a general trend for DMI fungicides. The only exception was prothioconazole, which was launched in 2010, although it had been assessed since 2005/2006. Because of the reduced efficacy of DMIs, prothioconazole was launched as a mixture with trifloxystrobin.”

The present invention provides an elegant solution to this problem of reducing fungicidal efficacy by providing a combination comprising broad-spectrum Succinate Dehydrogenase Inhibitors (SDHIs) fungicides mixed with quinone outside inhibitors (QoIs), and/or demethylation inhibitors.

Without wishing to be bound by theory, the present inventors believe that succinate dehydrogenase inhibitor fungicides due to their new mode of action, overcome and/or reduce the problems associated with ‘decrease in fungicidal efficacy over the years’. The need to reverse such problems with the efficacy of systemic fungicides was well recognized in the field of fungicidal combinations. The inventors of this application conducted studies set forth in the instant application to provide a long-awaited solution for the dreadful problem to the industry of fungicidal combinations.

The instant application, for the first time, describes a fungicidal combination comprising a succinate dehydrogenase inhibitor fungicide and two systemic fungicides from demethylation inhibitors and/or quinone outside inhibitors, to provide a long-awaited solution to the problem of maintaining efficacy of the combinations towards controlling fungi.

The present invention provides a fungicidal combination comprising at least one succinate dehydrogenase inhibitor fungicide, and at least one second and third systemic fungicide such as a quinone outside inhibitor fungicide or a demethylation inhibitor fungicide or a combination thereof for fungal control.

In addition to addressing the long-standing need in the industry, the synergistic complementation between the succinate dehydrogenase inhibitor fungicide and the combination of two other systemic fungicides was found to be unexpected and surprising.

The research conducted by the inventors, and the subject matter disclosed and claimed, in the instant application, found that the addition of a succinate dehydrogenase inhibitor fungicide to a combination of demethylation inhibitors or quinone outside inhibitors or a combination thereof reverses the decay of efficacy of the known combination and reverts it to the original known efficacy or better efficacy.

Studies showed that the addition of a SDHI fungicide to a strobilurin fungicide and/or a conazole fungicide or a combination thereof was surprisingly greater than what was expected from a knowledge of the improvement accruing to the efficacy of succinate dehydrogenase inhibitor fungicides with either the strobilurin fungicide or the conazole fungicide in isolation. It was consistently greater than at least 20% (i.e. double the improvement in the isolated succinate dehydrogenase inhibitor fungicides with strobilurin or the conazole fungicide).

Surprisingly, in the absence of the succinate dehydrogenase inhibitor fungicide, the fungicidal efficacy of these very fungicides was known to gradually decay with their usage over the years.

The incorporation of a succinate dehydrogenase inhibitor fungicide to these combinations reversed the decrease in the efficacy of controlling fungi by the combinations, which was surprising and unexpected.

The efficacy of cyproconazole+azoxystrobin mixture over six seasons reduced from 90% in 2003/04 to 2013/14 efficacy of only 41% control, and because of a succinate dehydrogenase inhibitor fungicide, this declining trend was reversed.

For cyproconazole+picoxystrobin mixture over six seasons, the efficacy reduced by 9.0% per year, reaching 37% control crop in 2013/14, and because of a succinate dehydrogenase inhibitor fungicide, this declining trend was reversed.

For epoxiconazole+pyraclostrobin mixture over six seasons, from the 2009/10 harvest the effectiveness of this mixture has been decreased by 12.6% per year, reaching the last harvest 23%, and because of the presence of a succinate dehydrogenase inhibitor fungicide, this trend was reversed.

From 2008/09 the average effectiveness of mixtures “cyproconazole+azoxystrobin”, “cyproconazole+picoxystrobin” and “epoxiconazole+pyraclostrobin” over six crops has been reduced by 9.0% per year, reaching 37% in the last harvest, and this trend was reversed due to the addition of a succinate dehydrogenase inhibitor fungicide.

The addition of a succinate dehydrogenase inhibitor fungicide not only enhances the percentage control, but also reverts the observed control to the original level of 80%.

The efficacy of these known dual combinations decayed by more than 50%, leading to the cancellation of these registrations by the Brazilian regulatory authority MAPA, leading to the failure of these fungicides, and that this failure was cured only by the addition of asuccinate dehydrogenase inhibitor fungicide.

The resulting triple combination of a succinate dehydrogenase inhibitor fungicide and at least two other systemic fungicides were also synergistic according to the Colby's formula.

It was found that a succinate dehydrogenase inhibitor fungicide, surprisingly enhances the efficacy in a triple combination (present invention) more than it does in a double combination.

Moreover, the addition of a succinate dehydrogenase inhibitor fungicide, to either a strobilurin fungicide or a conazole fungicide, did not significantly enhance the efficacy of the strobilurin or the conazole fungicide in isolation, but in fact was almost always antagonistic, being mildly additive (about +1.1%) to being critically antagonistic (varying from about −1.5 to about −10.0), but the benefits of adding a succinate dehydrogenase inhibitor fungicide to a double combination of systemic fungicides i.e. a combination comprising a conazole fungicide and a strobilurin fungicide, was unexpected and surprising. Upon addition of a succinate dehydrogenase inhibitor fungicide, to a strobilurin fungicide and a conazole fungicide combination, the resulting efficacy was surprisingly greater than what was expected from a knowledge of the improvement accruing to the efficacy of either the strobilurin fungicide or the conazole fungicide in isolation, and that it was consistently greater than 20% (i.e. double the improvement in the isolated strobilurin or the conazole fungicide), mostly greater than 30% (i.e. triple the improvement in the isolated strobilurin or the conazole fungicide), and preferably greater than 50% or about 60% (i.e. 5 or 6 times the improvement in the isolated strobilurin or the conazole fungicide);

The association of a succinate dehydrogenase inhibitor fungicide with commercial products based in mixtures of pyraclostrobin and epoxiconazole, picoxystrobin and ciproconazole and azoxystrobin and ciproconazole increased the yield synergistically.

The presence of a succinate dehydrogenase inhibitor fungicide reduced the sensitivity reduction factor (SRF) of the systemic fungicides to less than 1.0.

The presence of a succinate dehydrogenase inhibitor fungicide surprisingly reduces the phytotoxicity due to the resulting triple combination.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Fungicidal activity of synergistic mixtures of the combinations of present invention is represented in below tables. Combinations were tested for the control of Phakopsora pachyrhizi that cause Asian Soybean Rust on Soybean crop. Spray volume was 120 L/ha.

TABLE 1

| | | | Areas under the | |
|---|---|---|---|---|
| | | | disease progress | |
| Treatment No. | Treatment details | Actives (g of a.i./ha) | curves (AACPD) | Control |
| 1 | Check | Check | 1015.5 | 0.0 |
| 2 | Pyraclostrobin, | Pyraclostrobin (65), | 351.8 | 65.2 |
| | Epoxiconazole | Epoxiconazole (40) | | |
| | and Fluxapyroxad | and Fluxapyroxad (40) | | |
| 3 | Bixafen, | Bixafen (62.5), | 318.2 | 69.4 |
| | Prothioconazole | Prothioconazole (87.5) | | |
| | and Trifloxystrobin | and Trifloxystrobin (75) | | |
| 4 | Benzovindiflupyr, | Benzovindiflupyr (45), | 270.4 | 72.9 |
| | Cyproconazole | Cyproconazole (67.5) | | |
| | and Difenoconazole | and Difenoconazole (112.5) | | |
| 5 | Fluindapyr, | Fluindapyr (70), | 324.8 | 69.4 |
| | Prothioconazole | Prothioconazole (70) | | |
| | & Cyproconazole | and Cyproconazole (70) | | |
| 6 | Fluindapyr and | Fluindapyr (85) | 371.6 | 62.9 |
| | Tetraconazole | and Tetraconazole (82.5) | | |
| 7 | Picoxystrobin | Picoxystrobin (60) | 408.2 | 60.5 |
| | and Prothioconazole | and Prothioconazole (70) | | |

Treatment number 2, 3 and 4 are market standards. Treatment number 5 is combination of the present invention. Treatment number 6 and 7 are comparative examples. It can be seen clearly that for treatment 5, AACPD is less than treatment 6 and 7 and is like market standards. It can be seen clearly that for treatment 5, % control is more than treatment 6 and 7 and is like market standards.

TABLE 2

| | | | Areas under the | |
|---|---|---|---|---|
| | | | disease progress | |
| Treatment No. | Treatment details | Actives (g of a.i./ha) | curves (AACPD) | Control |
| 1 | Check | Check | 691.2 | 0.0 |
| 2 | Pyraclostrobin, | Pyraclostrobin (65), | 191.1 | 69.6 |
| | Epoxiconazole | Epoxiconazole (40) | | |
| | and Fluxapyroxad | and Fluxapyroxad (40) | | |
| 3 | Bixafen, | Bixafen (62.5), | 217.7 | 70.5 |
| | Prothioconazole | Prothioconazole (87.5) | | |
| | and Trifloxystrobin | and Trifloxystrobin (75) | | |
| 4 | Benzovindiflupyr, | Benzovindiflupyr (45), | 180.0 | 71.6 |
| | Cyproconazole | Cyproconazole (67.5) | | |
| | and Difenoconazole | and Difenoconazole (112.5) | | |
| 5 | Fluindapyr, | Fluindapyr (70), | 240.9 | 67.0 |
| | Prothioconazole | Prothioconazole (70) | | |
| | and Cyproconazole | and Cyproconazole (70) | | |
| 6 | Fluindapyr and | Fluindapyr (85) | 341.2 | 50.8 |
| | Tetraconazole | and Tetraconazole (82.5) | | |
| 7 | Picoxystrobin | Picoxystrobin (60) | 406.4 | 43.7 |
| | and Prothioconazole | and Prothioconazole (70) | | |

Treatment number 2, 3 and 4 are market standards. Treatment number 5 is combination of the present invention. Treatment number 6 and 7 are comparative examples. It can be seen clearly that for treatment 5, AACPD is less than treatment 6 and 7 and is like market standards. It can be seen clearly that for treatment 5, % control is more than treatment 6 and 7 and is like market standards.

Thus, it is concluded that combinations or compositions of the present invention are effective for targeted weed control.

1. A fungicidal combination comprising:
(a) at least one SDHI fungicide; and
(b) at least two systemic fungicides.

2. The fungicidal combination as claimed in claim 1, wherein the at least two systemic fungicides are
DMI fungicides.

3. The fungicidal combination as claimed in claim 1, wherein the at least two systemic fungicides are
QOI fungicides.

4. The fungicidal combination as claimed in claim 1, wherein the at least two systemic fungicides are
at least one DMI fungicides and at least one QOI fungicide.

5. The fungicidal combination as claimed in claim 1, wherein the SDHI fungicide is selected from the group consisting of benodanil, flutolanil, mepronil, isofetamid, fluopyram, fenfuram, carboxin, oxycarboxin, thifluzamide, pydiflumetofen; isoflucypram, pyraziflumid, isofetamid, boscalid, and combinations thereof.

6. The fungicidal combination as claimed in claim 2, wherein the at least two DMI fungicides are selected from the group consisting of azaconazole, bitertanol, bromuconazole, cyproconazole, difenconazole, diniconazole, epoxiconazole, etaconazole, fenbuconazole, fluquinconazole, flusilazole, flutriafol, hexaconazole, imibenconazole, ipconazole, mefentrifluconazole, metconazole, myclobutanil, penconazole, propiconazole, simeconazole, tebuconazole, tetraconazole, triadimefon, triadimenol, triticonazole, prothioconazole, and combinations thereof.

7. The fungicidal combination as claimed in claim 3, wherein the at least two QOI fungicides are selected from the group consisting of azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimoxystrobin, fenaminstrobin, metominostrobin, orysastrobin, famoxadone, fluoxastrobin, fenamidone, pyribencarb, and combinations thereof.

8. The fungicidal combination as claimed in claim 1 comprising:
(a) prothioconazole;
(b) cyproconazole; and fluindapyr.

9. The fungicidal combination of claim 1, wherein the
(a) at least one SDHI fungicide; and
(b) at least two systemic fungicides are selected from DMI fungicides, QoI fungicides or a combination of DMI fungicides and QoI fungicides.

10. A method of controlling fungal diseases comprising applying the combination of claim 1 to a plant or its locus.
